(19) United States
(12) Patent Application Publication
(10) Pub. No.: US 2022/0118983 A1
(43) Pub. Date: Apr. 21, 2022

(54) DISPLAY CONTROL DEVICE AND DISPLAY CONTROL PROGRAM PRODUCT

(71) Applicant: DENSO CORPORATION, Kariya-city (JP)

(72) Inventors: Akihiko YAGYU, Kariya-city (JP); Daisuke TAKEMORI, Kariya-city (JP); Yasuhiro SHIMIZU, Kariya-city (JP); Kazuki KOJIMA, Kariya-city (JP); Shiori MANEYAMA, Kariya-city (JP)

(73) Assignee: DENSO CORPORATION, Kariya-city (JP)

(21) Appl. No.: 17/563,386

(22) Filed: Dec. 28, 2021

Related U.S. Application Data
(63) Continuation of application No. PCT/JP2020/016495, filed on Apr. 15, 2020.

(30) Foreign Application Priority Data
Jul. 2, 2019 (JP) 2019-123833
Mar. 27, 2020 (JP) 2020-058521

(51) Int. Cl. B60W 30/18; B60W 10/20; G06V 20/56; B62D 15/02

(52) U.S. Cl. CPC B60W 30/18163; B62D 15/0255; G06V 20/588; B60W 10/20

(57) ABSTRACT

A display control device is used for a vehicle having a function of performing a lane change control based on a driver's input to control a display on a head-up display. The display control device acquires route information of the vehicle, and displays a route guidance content providing a route guidance based on the route information to be superimposed on a road surface, and displays a lane change content indicating a control content of the lane change control to be superimposed on a road surface. When a display request to display one of the route guidance content and the lane change content is generated while the other is being displayed, the display control device displays the lane change content in preference to the route guidance content.

### CROSS REFERENCE TO RELATED APPLICATIONS

The present application is a continuation application of International Patent Application No. PCT/JP2020/016495 filed on Apr. 15, 2020, which designated the U.S. and claims the benefit of priority from Japanese Patent Applications No. 2019-123833 filed on Jul. 2, 2019 and No. 2020-058521 filed on Mar. 27, 2020. The entire disclosures of all of the above applications are incorporated herein by reference.

### TECHNICAL FIELD

The present disclosure relates to a display control device and a display control program product to control a display on a head-up display.

### BACKGROUND

In a vehicle display control device, as a route guidance to a destination, it has been proposed to use a head-up display to display a guidance such as an arrow for guiding a lane change.

### SUMMARY

The present disclosure provides a display control device used for a vehicle having a function of performing a lane change control based on a driver's input to control a display on a head-up display. The display control device acquires route information of the vehicle, and displays a route guidance content providing a route guidance based on the route information to be superimposed on a road surface, and displays a lane change content indicating a control content of the lane change control to be superimposed on a road surface. When a display request to display one of the route guidance content and the lane change content is generated while the other is being displayed, the display control device displays the lane change content in preference to the route guidance content.

### BRIEF DESCRIPTION OF DRAWINGS

Features and advantages of the present disclosure will become more apparent from the following detailed description made with reference to the accompanying drawings, in which:

FIG. 1 is a diagram illustrating an overview of an in-vehicle network including a HCU according to a first embodiment of the present disclosure;

FIG. 2 is a diagram illustrating a head-up display mounted on a vehicle;

FIG. 3 is a diagram illustrating a schematic configuration of the HCU;

FIG. 4 is a diagram visually illustrating simulation of a display layout provided by a display generation unit;

FIG. 5 is a diagram illustrating details of display arbitration to preferentially display a lane change content in an exit scene at a turnout point;

FIG. 6 is a diagram illustrating a display transition when there is another vehicle that hinders a lane change of a subject vehicle in an exit scene at a turnout point;

FIG. 7 is a diagram illustrating a display transition to change a mode of a priority display with a remaining distance in an exit scene at a turnout point;

FIG. 8 is a diagram illustrating details of a priority display in a case where a movement direction indicated by route information and a movement direction by a lane change control do not coincide with each other in an exit scene at a turnout point;

FIG. 9 is a diagram illustrating details of a display transition in a case where a movement to a guidance destination lane Lng is unavailable in an exit scene at a turnout point, together with FIG. 10 or 11;

FIG. 10 is a diagram illustrating details of a display arbitration in a case where rerouting is performed by a navigation device after passing through a turnout point, together with FIG. 9;

FIG. 11 is a diagram illustrating details of a display arbitration in a case where rerouting is performed by a navigation device after passing through a turnout point, together with FIG. 9;

FIG. 12 is a flowchart illustrating details of a display control process according to the first embodiment, together with FIG. 13;

FIG. 13 is a flowchart illustrating details of the display control process together with FIG. 12;

FIG. 14 is a flowchart illustrating details of a display control process for keeping the display of a route guidance content waiting until a guidance area approaches;

FIG. 15 is a diagram illustrating details of a priority display when a display request for a route guidance content occurs during a display of a lane change content;

FIG. 16 is a flowchart illustrating details of a display control process for realizing the priority display shown in FIG. 15;

FIG. 17 is a diagram illustrating details of a priority display according to a second embodiment;

FIG. 18 is a diagram illustrating details of a priority display according to the second embodiment;

FIG. 19 is a diagram illustrating details of a priority display according to a third embodiment;

FIG. 20 is a diagram illustrating details of a priority display according to the third embodiment;

FIG. 21 is a diagram illustrating details of a priority display according to a fourth embodiment;

FIG. 22 is a diagram illustrating details of a priority display according to a fifth embodiment;

FIG. 23 is a diagram illustrating details of a priority display according to a sixth embodiment;

FIG. 24 is a diagram illustrating details of a priority display according to the sixth embodiment;

FIG. 25 is a diagram illustrating details of a priority display according to the sixth embodiment;

FIG. 26 is a diagram illustrating details of a priority display according to a seventh embodiment;

FIG. 27 is a diagram illustrating details of a priority display according to an eighth embodiment;

FIG. 28 is a diagram illustrating details of a priority display according to the eighth embodiment;

FIG. 29 is a flowchart illustrating details of a display control process of the eighth embodiment together with FIG. 12;

FIG. 30 is a diagram illustrating a priority display according to a first modification;

FIG. 31 is a diagram illustrating a priority display according to a second modification;

FIG. 32 is a diagram illustrating a priority display according to a fifth modification; and

FIG. 33 is a flowchart illustrating details of a display control process according to a sixth modification.

### DETAILED DESCRIPTION

In recent years, devices to assist a lane change or devices to act for a lane change have been installed in vehicles. It is expected that such vehicles will be required to display content indicating the control contents of the lane change control (hereinafter referred to as lane change content).

For example, the lane change content may be a content indicating the moving direction of the own vehicle, similar to a guidance display indicated by such as an arrow. If these contents indicating the moving direction of the vehicle are displayed at the same time, there is a possibility that the recognition by the driver becomes difficult.

The present disclosure provides a display control device, a display control program, and a non-transitory computer-readable storage medium, which are capable of displaying contents that are easily recognized by a driver.

According to an aspect of the present disclosure, a display control device is used for a vehicle that is capable of performing a lane change control based on a driver's input and controls a display by a head-up display. The display control device includes a route information acquisition unit that acquires route information of the vehicle; and a display control unit that displays a route guidance content providing a route guidance based on the route information to be superimposed on a road surface, and a lane change content indicating a control content of a lane change control to be superimposed on a road surface. In response to a display request to display one of the route guidance content and the lane change content being generated while the other is being displayed, the display control unit displays the lane change content in preference to the route guidance content.

According to an aspect of the present disclosure, a display control program is used in a vehicle that is capable of performing a lane change control based on a driver's input and controls a display by a head-up display. The display control program causes one or more processors to perform a process including; acquiring a route information of the vehicle; display a route guidance content providing a route guidance based on the route information to be superimposed on a road surface; display a lane change content indicating a control content of the lane change control to be superimposed on a road surface; and in response to a display request to display one of the route guidance content and the lane change content being generated while the other is being displayed, displaying the lane change content in preference to the route guidance content.

According to an aspect of the present disclosure, a display control program product used in a vehicle that is capable of performing a lane change control based on a driver's input and controls a display by a head-up display. The display control program product is stored in a computer-readable non-transitory tangible storage medium, and includes instructions to be executed by one or more processors. The instructions include: acquiring a route information of the vehicle; display a route guidance content providing a route guidance based on the route information to be superimposed on a road surface; display a lane change content indicating a control content of the lane change control to be superimposed on a road surface; and in response to a display request to display one of the route guidance content and the lane change content being generated while the other is being displayed, displaying the lane change content in preference to the route guidance content.

In these aspects, when the superimposed display of the route guidance content and the superimposed display of the lane change content are assumed to overlap each other, the superimposed display of the lane change content is given priority over the superimposed display of the route guidance content. According to the priority display of such a lane change content, it is possible to avoid a situation in which the recognition by the driver becomes difficult due to the two contents indicating the moving direction of the vehicle being displayed similarly. As a result, content display easy for a driver to recognize is implemented.

### First Embodiment

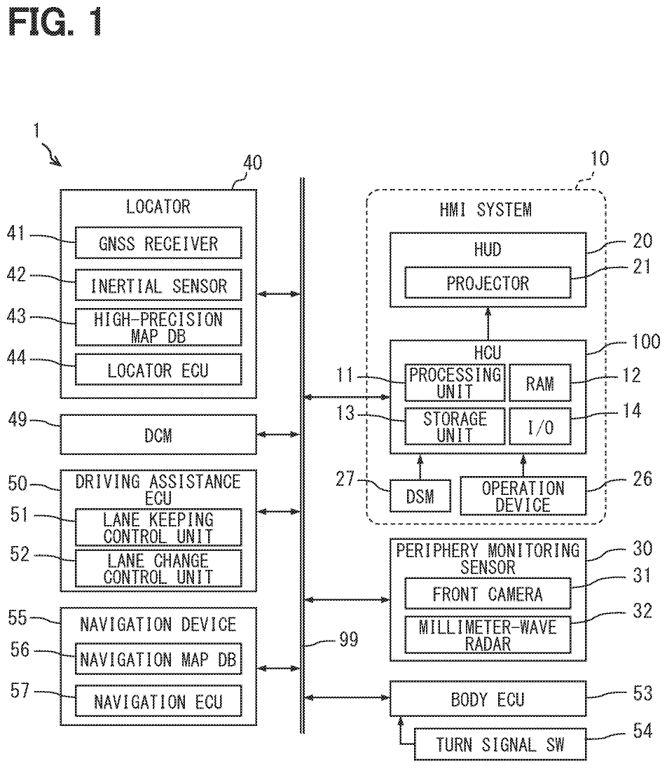

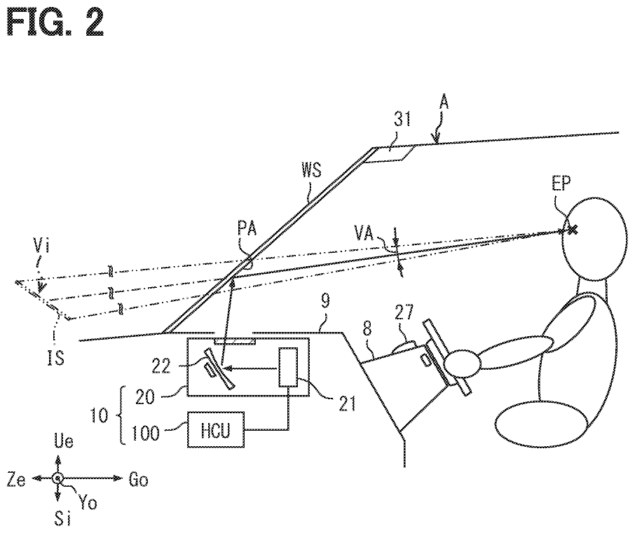

Functions of a display control device according to a first embodiment of the present disclosure is provided by a human machine interface (HMI) control unit 100 shown in FIGS. 1 and 2. Hereinafter, the HMI control unit 100 is also referred to as an HCU 100. The HCU 100 constitutes a human machine interface (HMI) system 10 used in a vehicle A together with a head-up display (hereinafter, HUD) 20 and the like. The HMI system 10 further includes an operation device 26, a driver status monitor (hereinafter, DSM) 27, and the like. The HMI system 10 has an input interface function that accepts a user's operation made by an occupant (for example, a driver) of the vehicle A, and an output interface function that presents information to the driver.

The HMI system 10 is communicably connected to a communication bus 99 of an in-vehicle network 1 mounted on the vehicle A. The HMI system 10 is one of multiple nodes included in the in-vehicle network 1. A periphery monitoring sensor 30, a locator 40, a data communication module (DCM) 49, a driving assistance electronic control unit (ECU) 50, a body ECU 53, a navigation device 55, and the like are connected to the communication bus 99 of the vehicle-mounted network 1 as nodes. These nodes connected to the communication bus 99 can communicate with one another. The specific nodes of these devices and ECUs may be electrically, directly connected to each other to communicate with each other without passing through the communication bus 99.

In the following description, a front-rear direction (see FIG. 2, Ze corresponding to forward, and Go corresponding to rearward) and a left-right (see FIG. 2, Yo corresponding to sideways) are defined with reference to the vehicle A motionlessly stationed on a horizontal plane. Specifically, the front-rear direction is defined along the longitudinal direction (traveling direction) of the vehicle A. The left-right direction is defined along a width direction of the vehicle A. Further, a vertical direction (see FIG. 2, Ue corresponding to upward and Si corresponding to downward) is defined along a direction vertical to the horizontal plane that defines the front-rear direction and the left-right direction. Further, for the sake of simplification of the description, the description of the reference numeral indicating each direction may be omitted as appropriate.

The periphery monitoring sensor 30 is an autonomous sensor that monitors a peripheral environment of the vehicle A. The periphery monitoring sensor 30 can detect moving objects and stationary objects in a detection range around the subject vehicle. The moving objects include pedestrians, cyclists, non-human animals, and other vehicles, for example. The stationary objects include falling objects on the road, guardrails, curbs, road signs, road markings such as road lane lines, and structures beside the road, for example. The periphery monitoring sensor 30 provides detection information of detecting an object around the vehicle A to the driving assistance ECU 50 and the like via the communication bus 99.

The periphery monitoring sensor 30 includes a front camera 31, a millimeter wave radar 32, and the like as detection configurations for object detection. The front camera 31 outputs at least one of image data obtained by photographing the front range of the vehicle A and an analysis result of the image data, as detection information. The multiple millimeter wave radars 32 are arranged, for example, on the front and rear bumpers of the vehicle A at intervals from each other. The millimeter wave radar 32 emits millimeter waves or quasi-millimeter waves toward a front range, a front side range, a rear range, a rear side range, or the like of the vehicle A. The millimeter wave radar 32 generates detection information by a process of receiving reflected waves reflected by moving objects, stationary objects, or the like. The vicinity monitoring sensor 30 may include detection configurations such as a lidar and a sonar.

The locator 40 generates highly accurate position information of the vehicle A by a complex positioning method that combines multiple types and pieces of acquired information. The locator 40 includes a global navigation satellite system (GNSS) receiver 41, an inertial sensor 42, a high-precision map database (hereinafter, high-precision map DB) 43, and a locator ECU 44.

The GNSS receiver 41 receives positioning signals transmitted from multiple artificial satellites, such as positioning satellites. The GNSS receiver 41 is capable of receiving positioning signals from respective positioning satellites of at least one satellite positioning system among multiple satellite positioning systems such as GPS, GLONASS, Galileo, IRNSS, QZSS, and Beidou.

The inertial sensor 42 includes a gyro sensor and an acceleration sensor, for example. The high-precision map DB 43 is mainly composed of a non-volatile memory, and stores map data (hereinafter, high-precision map data) having higher accuracy than the map data used in the navigation device 55. The high-precision map data holds detailed information at least for information in the height (z) direction. The high-precision map data contains information that can be used for advanced driving assistance and automated driving, such as three-dimensional shape information about roads, information about the number of lanes, and information indicating a traveling direction allowed for each lane. Further, the high-precision map data includes information on node points indicating the positions of both ends of a road marking such as a white line.

The locator ECU 44 mainly includes a microcomputer equipped with a processor, RAM, a storage unit, an input/output interface, and a bus connecting these elements. The locator ECU 44 combines positioning signal received by the GNSS receiver 41, measurement result of the inertial sensor 42, vehicle speed information output to the communication bus 99, and the like, and successively specifies the position and the traveling direction of the vehicle A. The locator ECU 44 can provide position information and direction information of the vehicle A based on the positioning result to the navigation device 55, the HCU 100, the driving support ECU 50 and the like as the locator information. In addition, the locator ECU 44 can provide the requested high-precision map data to the requesting ECU in response to the request from the HCU 100, the operation support ECU 50, and the like.

The DCM 49 is a communication module mounted on the subject vehicle A. The DCM49 transmits and receives radio waves to and from base stations around the vehicle A by wireless communication compliant with communication standards such as long term evolution (LTE) and 5G. The DCM 49, when mounted, enables the vehicle A to be connect to the Internet. The DCM49 can receive the latest high-precision map data from a server provided on a cloud. The DCM49 cooperates with the locator ECU 44 to update the high-precision map data stored in the high-precision map DB 43 to the latest information.

The driving assistance ECU 50 mainly includes a computer equipped with a processor, RAM, a storage unit, an input/output interface, a bus connecting these elements, and the like. The driving assistance ECU 50 has a driving assistance function to assist the driving operation of a driver. The driving support ECU 50 has a driving support function that assists the driver's driving operation, or an automatic driving function that can substitute the driver's driving operation. As an example, the driving support ECU 50 enables advanced driving assistance or partial automatic driving control of about level 2 to 3 at the automatic driving level specified by the American Society of Automotive Engineers of Japan.

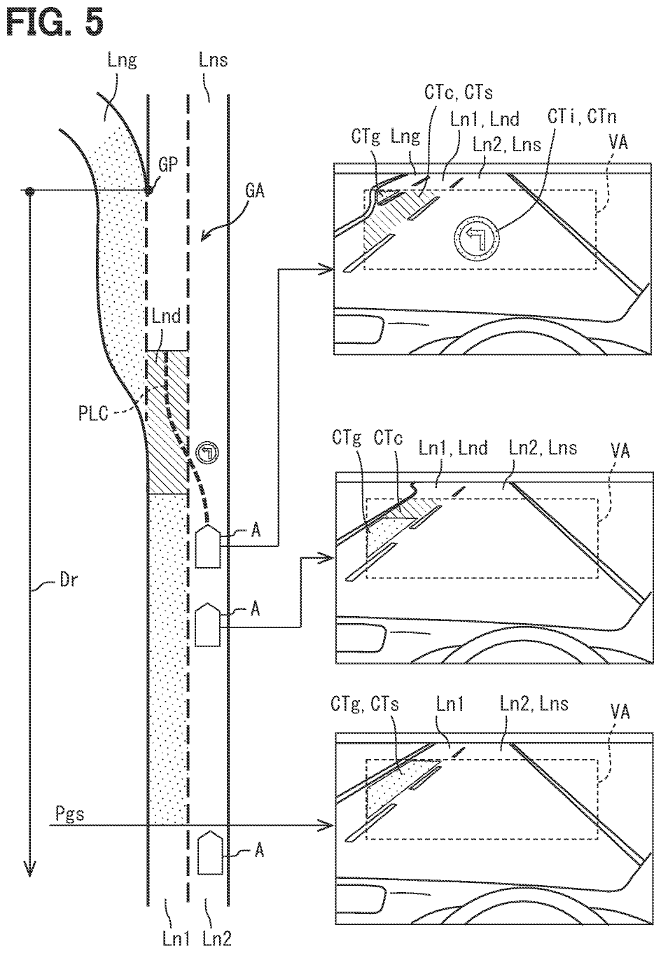

The driving assistance ECU 50 recognizes the driving environment around the vehicle A for the driving control described later based on the detection information acquired from the periphery monitoring sensor 30. As an example, on a road having a plurality of lanes, the driving assistance ECU 50 specifies the lane on which the vehicle A is currently traveling (hereinafter, subject vehicle lane Lns, see FIG. 5) from the plurality of lanes. More specifically, the driving assistance ECU 50 recognizes the shape of the left and right lane markings or road edges of the subject vehicle lane Lns, and matches the recognized boundary shape with the shape of the lane marking registered in the high-precision map data based on the locator information. Through such matching processing, the driving assistance ECU 50 generates information indicating relative positions of the subject vehicle lane Lns, the adjacent lane Lnd, and the like (hereinafter referred to as lane identification information), and provides the information to the HCU 100. As described above, the left-right direction referred herein is a direction that coincides with the width direction of the vehicle A stationary on the horizontal plane, and is set with reference to the traveling direction of the vehicle A.

The driving assistance ECU 50 has a plurality of functional units that realize automatic driving or driving support by executing a program by a processor. Specifically, the driving assistance ECU 50 includes an adaptive cruise control (ACC) unit, a lane keeping control unit 51, and a lane change control unit 52. The ACC control unit is a functional unit that realizes the function of ACC for driving the vehicle A at a constant speed as a target vehicle speed or for driving the vehicle A to follow a leading vehicle while maintaining an inter-vehicular distance from the leading vehicle.

The lane keeping control unit 51 is a functional unit that realizes the function of lane tracing assist (LTA) that controls the vehicle to travel in a lane. The LTA is also referred to as a lane trace control (LTC). The lane keeping control unit 51 controls the steering angle of the steering wheel of the vehicle A based on the recognition information on such as the lane markings extracted from the imaging data of the front camera 31 and the like. The lane keeping control unit 51 cooperates with the ACC control unit to perform driving control (lane keeping control or lane following control) for the vehicle A to continue traveling along the subject vehicle lane Lns (hereinafter, referred to as an in-lane traveling).

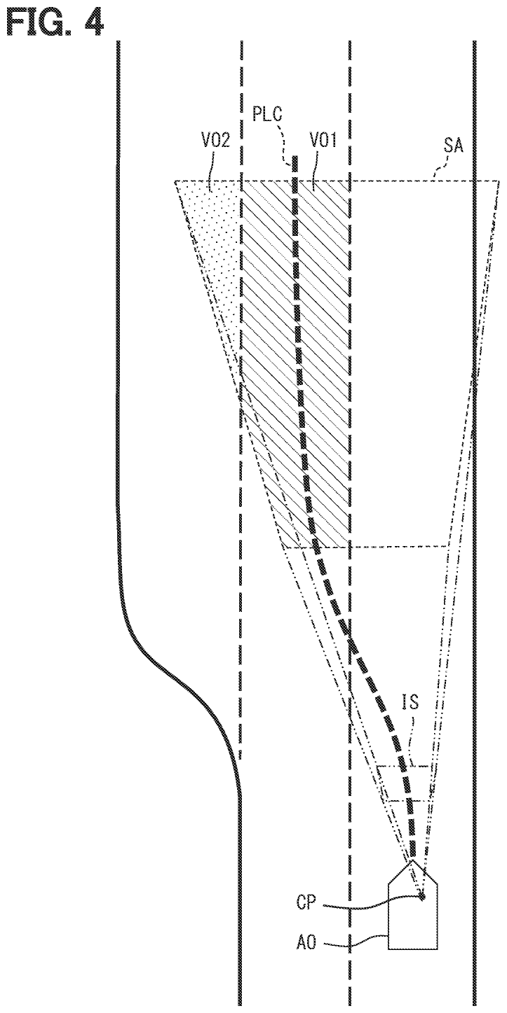

The lane change control unit 52 is a functional unit that realizes the function of lane change assist (LCA) that controls the lane change of the vehicle A. The lane change control unit 52 generates, based on an on-operation of a driver or the like instructing the execution of LCA, a traveling trajectory (see FIG. 4, lane change trajectory PLC) from the subject vehicle lane Lns to an adjacent lane Lnd (see FIG. 5) as a destination lane of the lane change while referring to the high-precision map data. The lane change control unit 52 allows temporary interruption of the driving control of the in-lane traveling by the lane keeping control unit 51, and enables the vehicle A to leave from the subject vehicle lane Lns. Under such a state, the lane change control unit 52 automatically controls the steering angle of the steering wheel of the vehicle A according to the lane change trajectory PLC, thereby to execute the lane change from the subject vehicle lane Lns to the adjacent lane Lnd. When the lane change by the lane change control unit 52 is completed, the lane keeping control unit 51 restarts the driving control of the in-lane traveling.

When the LCA function is activated in accordance with the on operation, the lane change control unit 52 successively provides the HCU 100 with lane change information (hereinafter, LCA information) relating to the lane change. The LCA information includes at least line shape information and status information.

The line shape information is information that defines the shape of the above-mentioned lane change trajectory PLC. Based on the line shape information, the HCU 100 can restore the shape of the lane change trajectory PLC. The data format of the line shape information may be appropriately changed if the shape of the traveling trajectory can be restored by the HCU 100. As an example, the line shape information has a data format including three-dimensional coordinate information of a plurality of specific points on the lane change trajectory PLC and information such as the length and radius of curvature of a virtual line connecting each specific point. As another example, the line shape information has a data format including three-dimensional coordinate information of a large number of points arranged at predetermined intervals on the lane change trajectory PLC.

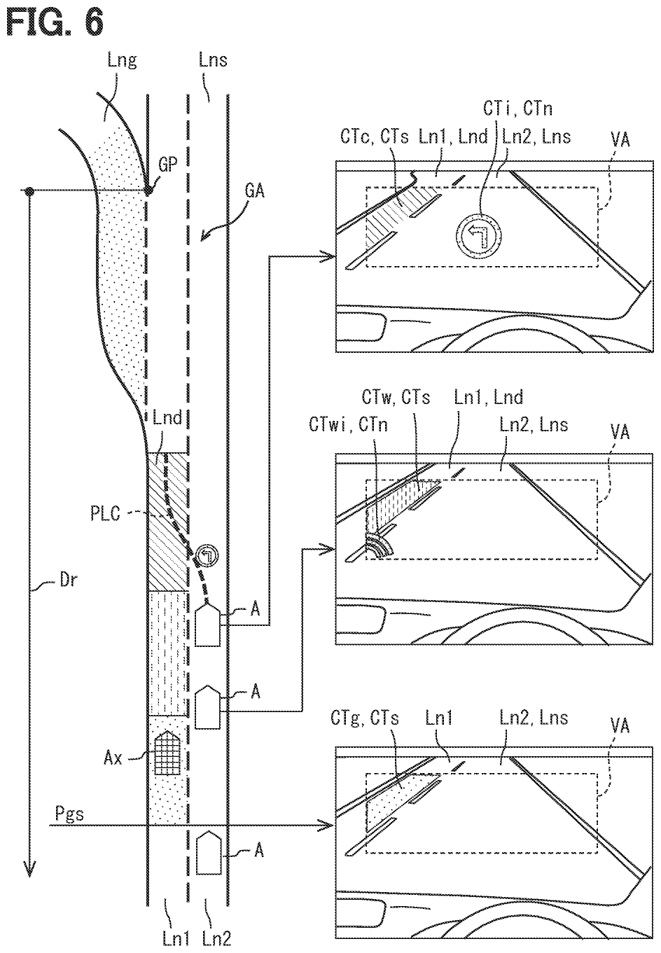

The status information is information indicating whether the activation state of the LCA function is any of a start-up state, a standby state, and an execution state. The start-up state is the state immediately after the on operation is accepted. In the start-up state, based on the detection information, it is confirmed whether or not another vehicle Ax (see FIG. 6) exists in the adjacent lane Lnd (see FIG. 5) which is the destination of the lane change (hereinafter, peripheral check). When the peripheral check is finished, the activation state of the LCA function is set to either the standby state or the execution state. As a result of the peripheral check, if there is another vehicle Ax that hinders the lane change of the subject vehicle, the LCA function is in the standby state. On the other hand, when there is no other vehicle Ax that hinders the lane change of the subject vehicle, the LCA function changes from the start-up state or the standby state to the execution state of starting the lane change.

The body ECU 53 mainly includes a microcontroller equipped with a processor, RAM, a storage unit, an input/output interface, and a bus connecting these elements. The body ECU 53 has at least a function of controlling the operation of a lighting device mounted on the vehicle A, such as a headlight and a turn signal indicator (winker). The body ECU 53 is electrically connected to a turn signal switch 54.

The turn signal switch 54 is a lever-shaped operation unit provided on a steering column unit 8. The body ECU 53 starts blinking one of the left and right turn signals corresponding to the operation direction applied to the turn signal switch 54, based on the detection of the user's operation input to the turn signal switch 54. The turn signal switch 54 receives a normal user operation to start the blinking operation of the turn signal in the state of manual driving, as well as the on operation made to instruct the execution of the lane change control to the lane change control unit 52 in the state where the LTC function is in the activation state. As an example, a user operation in which the turn signal switch 54 is half-pressed for a predetermined time (for example, about 1 to 3 seconds) is regarded as the on operation for the LCA function.

When detecting the input of the on operation of the LCA function, the body ECU 53 outputs the on operation information to the driving assistance ECU 50. The driving assistance ECU 50 acquires from the body ECU 53 information indicating that the on operation has been input, information indicating the left or right input direction of the on operation, and the like, as the on operation information. The operation of the turn signal switch 54 in the direction opposite to the on operation is regarded as the cancellation operation of the LCA function. Further, steering operation, accelerator operation, brake operation and the like exceeding a specific operation amount by the driver are also regarded as the cancellation operations of the LCA function.

The navigation device 55 is an in-vehicle device that cooperates with the HMI system 10 to provide a route guidance to a destination set by the driver. The navigation device 55 includes a map database for navigation (hereinafter, navigation map DB) 56, a navigation ECU 57, and the like. The navigation map DB 56 is mainly composed of a non-volatile memory, and comprehensively stores map data (hereinafter referred to as navigation map data) in a wider range than the high-precision map DB 43. The navigation map data includes link data, node data, shape data, and the like for roads.

The navigation ECU 57 is mainly composed of a microcomputer including a processor, RAM, a storage unit, an input/output interface, and a bus connecting these elements. The navigation ECU 57 acquires locator information from the locator ECU 44. When the route to the destination has been set, the navigation ECU 57 provides a driver with a guidance of a traveling direction of the vehicle A in a guidance area GA included in the set route, in the vicinity of the guidance area GA in combination with a screen display, a voice message, and the like.

In addition, the navigation ECU 57 outputs route information to the destination to the HCU 100. When the vehicle A approaches the guidance area GA, the navigation ECU 57 outputs a guidance execution request requesting the execution of route guidance using the virtual image Vi to the HCU 100. Further, when the navigation ECU 57 determines the deviation from the set route of the vehicle A, the navigation ECU 57 automatically re-searches for a new route to the destination by a reroute function. When a new route is set by the reroute function, the navigation ECU 57 outputs the guidance execution request requesting the start of guidance of the updated set route to the HCU 100.

The guidance area GA is a point where the route guidance is performed. The guidance area GA includes intersections, branch points and confluence points, as well as destinations and waypoints. Further, the guidance execution request includes information indicating the position of the guidance area GA, the direction in which the vehicle A should travel in the guidance area GA, and the like.

Here, instead of the navigation device 55, a user terminal such as a smartphone may be connected to the in-vehicle network 1 or the HCU 100. For an application executed on the user terminal, the route to the destination is set based on a user's operation such as a driver's operation. Similar to the navigation device 55, the user terminal provides a guidance of the traveling direction of the vehicle A in combination with a screen display, a voice message, or the like, at an intersection, a branch point, and the like.

Next, the operation device 26, the DSM 27, the HUD 20, and the HCU 100 included in the HMI system 10 will be described in detail in turn.

The operation device 26 is an input unit that accepts an operation of user, such as a driver. The operation device 26 receives the user operation for switching, for example, the driving assistance function and the automatic driving function between an activated state and a deactivated state. Specifically, the operation device 26 includes a steering switch provided on a spoke portion of the steering wheel, an operation lever provided on a steering column portion 8, a voice input device for detecting the driver's voice or speech, and the like.

The DSM27 includes a near-infrared light source, a near-infrared camera, and a control unit for controlling the near-infrared light source and the near-infrared camera. The DSM 27 is installed, for example, on the upper surface of the steering column portion 8 or the upper surface of the instrument panel 9, so that the near-infrared camera faces the headrest portion of the driver's seat. The DSM 27 uses the near-infrared camera to capture the driver's head to which the near-infrared light is emitted from the near-infrared light source. The control unit performs an image analyzing process to the image captured by the near-infrared camera. The control unit extracts information such as positions and eye directions of the eye point EP from the captured image, and successively outputs the state information extracted to the HCU 100.

The HUD 20 is mounted on the vehicle A as one of a plurality of in-vehicle display devices, together with a meter display or the like. The HUD 20 is electrically connected to the HCU 100 and successively acquires video data generated by the HCU 100. Based on the video data, the HUD 20 presents various information related to the vehicle A, such as route information, sign information, and status information of each in-vehicle function, to the driver using the virtual image Vi.

The HUD 20 is accommodated in a housing space inside the instrument panel 9 below a windshield WS. The HUD 20 projects the light formed as a virtual image Vi toward the projection range PA of the windshield WS. The light projected on the windshield WS is reflected toward the driver's seat in the projection range PA and is perceived by the driver. The driver visually recognizes a display in which a virtual image Vi is superimposed on the foreground visible through the projection range PA.

The HUD 20 includes a projector 21 and a magnifying optical system 22. The projector 21 includes an liquid crystal display (LCD) panel and a backlight. The projector 21 is fixed to a housing of the HUD 20 so that the display surface of the LCD panel faces the magnifying optical system 22. The projector 21 displays each frame image of the video data on the display surface of the LCD panel, and illuminates the display surface with the backlight that transmits the display surface. Thus, the light to be formed as a virtual image Vi is emitted toward the magnifying optical system 22. The magnifying optical system 22 is configured to include at least one optical element such as a concave mirror. The magnifying optical system 22 projects the light emitted from the projector 21 on an upper projection range PA while spreading the light by reflection.

The HUD 20 is given an angle of view VA. When a virtual range in the space where the virtual image Vi can be imaged by the HUD 20 is defined as an imaging plane IS, the angle of view VA is defined as a viewing angle defined based on an virtual line connecting the driver's eye point EP and an outer edge of the image plane IS. The angle of view VA is a range of angle within which the driver can visually recognize the virtual image Vi when viewed from the eye point EP. In the HUD 20, a horizontal angle of view (for example, about 10 degrees to 12 degrees) in the horizontal direction is larger than a vertical angle of view (for example, about 4 degrees to 5 degrees) in the vertical direction. When viewed from the eye point EP, the front range (for example, a range of about a dozen m to 100 m) that overlaps with the image plane IS is the range within the angle of view VA.

The HUD 20 displays a superimposition content CTs (see FIG. 5 and the like) and a non-superimposition content CTn (see FIG. 5 and the like) as virtual images Vi. The superimposition content CTs is an AR display object used for augmented reality (hereinafter referred to as “AR”) display. The display position of the superimposition content CTs is associated with a specific superimposition target existing in the foreground, such as a specific position on the road surface, a vehicle in front, a pedestrian, and a road sign. The superimposition content CTs is displayed in a superimposing manner on a specific superimposition target in the foreground, and is seemingly fixed relative to the specific superimposition target to be able to follow the specific superimposition target corresponding to the driver's eye line. That is, the relative positional relationship is continuously maintained among the driver's eye point EP, the superimposition target in the foreground, and the superimposition content CTs. Therefore, the shape of the superimposition content CTs is continuously updated at a predetermined cycle according to the relative position and shape of the superimposition target. The superimposition content CTs is displayed to be approximately leveled, as compared with the non-superimposition content CTn, and has a display shape extending in the depth direction (traveling direction, forward Ze) when viewed from the driver, for example.

The non-superimposition content CTn is a non-AR display object excluding the superimposition content CTs among the display objects displayed in the superimposing manner in the foreground. Unlike the superimposition content CTs, the non-superimposition content CTn is displayed in the superimposing manner on the foreground independently of the superimposition target. The display position of the non-superimposition content CTn is not associated with a specific superimposition target. The non-superimposition content CTn is displayed at a fixed position within the projection range PA (the above-mentioned angle of view VA). Therefore, the non-superimposition content CTn is displayed as if it is relatively fixed to the vehicle configuration such as the windshield WS. In addition, the shape of the non-superimposition content CTn is substantially constant. Due to the positional relationship between the vehicle A and the superimposition target, there may be a timing occurs at which even the non-superimposition content CTn is superimposedly displayed on the superimposition target of the superimposition content CTs.

The HCU 100 is an electronic control unit that integrally controls the display by in-vehicle display devices such as the meter display and the HUD 20 in the HMI system 10. The HCU100, the HUD20, and the like constitute a virtual image display system.

The HCU 100 mainly includes a computer equipped with a processing unit 11, a RAM 12, a storage unit 13, an input/output interface 14, and a bus connecting these elements. The processing unit 11 is a hardware combined with the RAM 12, and executes arithmetic processing. The processing unit 11 includes at least one arithmetic core, such as a central processing unit (CPU) or a graphics processing unit (GPU). The processing unit 11 may further include a field-programmable gate array (FPGA), a neural network processing unit (NPU), an IP core having other dedicated functions, and the like. The RAM 12 may include a video RAM for generating video. The processing unit 11 executes various processes for realizing the display control method of the present disclosure by accessing the RAM 12. The storage unit 13 includes a non-volatile storage medium. The storage unit 13 stores various programs (display control programs, etc.) to be executed by the processing unit 11.

The HCU 100 shown in FIGS. 1 to 3 has a plurality of functional units for controlling the superimposed display of the content by the HUD 20 by executing the display control program stored in the storage unit 13 by the processing unit 11. Specifically, the HCU 100 is provided with functional units such as a viewpoint position specifying unit 71, a route information acquisition unit 72, a locator information acquisition unit 73, a control information acquisition unit 74, and a display generation unit 76.

The viewpoint position specifying unit 71 specifies a position of the eye point EP of the driver seated on the driver seat based on the state information acquired from the DSM 27. The viewpoint position specifying unit 71 generates three-dimensional coordinates (hereinafter referred to as eye point coordinates) indicating the position of eye point EP, and successively provides the generated eye point coordinates to the display generation unit 76.

In a case where the destination has been set in the navigation device 55, the route information acquisition unit 72 acquires the route information for the route guidance to the destination and the navigation map data used for the route guidance from the navigation ECU 57. In addition, the route information acquisition unit 72 acquires the guidance execution request output by the navigation ECU 57 based on the approach to the guidance area GA. When the set route is updated due to a deviation from the set route of the vehicle A or the like, the route information acquisition unit 72 acquires the route information regarding the re-searched new set route. Specifically, the route information acquisition unit 72 acquires a guidance execution request for the set route after rerouting from the navigation ECU 57.

The locator information acquisition unit 73 acquires the locator information from the locator ECU 44. In addition, the locator information acquisition unit 73 acquires the provision of high-precision map data around the subject vehicle from the locator ECU 44. The locator information acquisition unit 73 acquires, for example, information on a range necessary for superimposed display of the superimposition content CTs (for example, about 50 m to 200 m around the vehicle A) from the locator ECU 44.

The route information acquisition unit 72 may not acquire the navigation map data in the range where the locator information acquisition unit 73 can acquire the high-precision map data. Further, in a case where the position of the subject vehicle lane Lns is specified by the locator 40, the locator information may include information corresponding to the lane identification information described above.

The control information acquisition unit 74 acquires the LCA information and the lane identification information output to the communication bus 99. As described above, the LCA information is the driving control information related to the lane change output to the communication bus 99 by the lane change control unit 52. The control information acquisition unit 74 sequentially provides the display generation unit 76 with the status information indicating the operation state of the LCA function and the line shape information indicating the shape of the lane change trajectory PLC.

The lane identification information is recognition information obtained by recognizing the traveling environment around the vehicle A. In place of such lane identification information, or together with the lane identification information, the control information acquisition unit 74 can acquire recognition information of the traveling environment corresponding to the lane identification information by image recognition processing using the image captured by the front camera 31. The control information acquisition unit 74 acquires the recognition information of the traveling environment in the range (see the above range) necessary for the superimposed display of the superimposition content CTs by in-vehicle communication or analysis. When acquiring the recognition information by the communication, the control information acquisition unit 74 may acquire the recognition information in the entire range that can be recognized by the driving assistance ECU 50, or acquires the recognition information in the range necessary for the superimposed display in a limited manner.

The display generation unit 76 controls the presentation of information to the driver by the HUD 20 by generating video data that is sequentially output to the HUD 20. The display generation unit 76 draws the original image of each content displayed as a virtual image Vi on each frame image constituting the video data. When drawing the original image of the superimposition content CTs (see FIG. 5 and the like) on the frame image, the display generation unit 76 corrects the drawing position and drawing shape of the original image in the frame image according to the eye point EP and the superimposition target. Thus, the superimposition content CTs is displayed at the position and shape correctly superimposed on the superimposition target when viewed from the eye point EP.

The display generation unit 76 further has a virtual layout function and a content selection function in order to realize the video data generation function described above. The virtual layout function is a function of simulating the display layout of the superimposition content CTs based on various information provided to the display generation unit 76. The display generation unit 76 can start the simulation of the display layout by its own judgment based on the information acquired by the control information acquisition unit 74. Specifically, when the route information acquisition unit 72 acquires the guidance execution request, or when the locator information acquisition unit 73 acquires the status information indicating the activation of the LCA function, the display generation unit 76 reproduces the current traveling environment of the vehicle A in the virtual space. The display generation unit 76 reproduces the traveling environment by appropriately using the route information, the locator information, the lane identification information, the high-precision map data, and the like.

More specifically, as shown in FIGS. 2 to 4, the display generation unit 76 sets a subject vehicle object AO at a reference position in the virtual three-dimensional space. The display generation unit 76 maps a road model of the shape indicated by the high-precision map data in the three-dimensional space in association with the subject vehicle object AO based on the locator information. The display generation unit 76 reproduces the lane change trajectory PLC having a shape based on the route information on the road model.

In addition, the display generation unit 76 sets a virtual camera position CP and a superimposition range SA in association with the subject vehicle object AO. The virtual camera position CP is a virtual position corresponding to the driver's eye point EP. The display generation unit 76 sequentially corrects the virtual camera position CP with respect to the subject vehicle object AO based on the latest eye point coordinates acquired by the viewpoint position specifying unit 71. The superimposition range SA is a range in which the virtual image Vi can be displayed in the superimposing manner. The display generation unit 76 sets a front range positioned inside the imaging plane IS as the superimposition range SA, when viewed forward from the virtual camera position CP, based on the virtual camera position CP and the outer edge position (coordinates) information of the imaging plane IS stored in advance in the storage unit 13 (see FIG. 1). The superimposition range SA corresponds to the angle of view VA of the HUD20.

Further, the display generation unit 76 arranges a first virtual object VO1 and a second virtual object VO2 on the road surface of the road model in the three-dimensional space. The first virtual object VO1 is an object that defines the shape of a lane change content CTc (see FIG. 5), which will be described later. The first virtual object VO1 is set in the virtual space when the lane change content CTc is displayed as a virtual image. The first virtual object VO1 is laid out in the virtual space based on the recognition information of the traveling environment such as the lane identification information. On the other hand, the second virtual object VO2 is an object that defines the shape of a route guidance content CTg (see FIG. 5), which will be described later. The second virtual object VO2 is set in the virtual space when the route guidance content CTg is displayed as a virtual image. The second virtual object VO2 is laid out in the virtual space mainly based on the route information and the locator information.

When setting both the first virtual object VO1 and the second virtual object VO2, the display generation unit 76 corrects the position of the second virtual object VO2 by using the recognition information so as to match the position of the first virtual object VO1. As a result, the superimposition position of the route guidance content CTg is adjusted visually according to the superimposition position of the lane change content CTc.

The shape of each of the virtual objects VO1 and VO2 as viewed from the virtual camera position CP corresponds to the virtual image shape of each of the contents CTc and CTg visually recognized from the eye point EP. In other words, the shape obtained by projecting each of the virtual objects VO1 and VO2 toward the virtual camera position CP on the virtual image plane IS is regarded as the virtual image shape of each superimposition content CTs. The display generation unit 76 calculates the virtual image shape and, by extension, a drawing shape of the original image from the shape of each of the virtual objects VO1 and VO2 based on the specification information of the optical system of the HUD 20.

A content selection function is, for example, a function for selecting a content to be used for presenting information. The display generation unit 76 properly uses a plurality of types of superimposition contents CTs and non-superimposition contents CTn, and presents information to the driver. The display generation unit 76 mediates the content to be displayed as a virtual image so that the information having high urgency and importance is preferentially presented to the driver.

An example of a specific traveling scene in which the content is arbitrated is an exit scene in which the subject vehicle A exits, at a branch point of an expressway, from a main line toward a lane (hereinafter referred to as a guidance destination lane Lng) connecting to a highway exit (see FIGS. 5 to 7 etc.). In such an exit scene, the display generation unit 76 may perform display arbitration of the route guidance content CTg and the lane change content CTc. The route guidance content CTg is a content that provides route guidance so as to move to the guidance destination lane Lng. On the other hand, the lane change content CTc is a content indicating the control content of the lane change control when the driver activates the LCA function for moving to the guidance destination lane Lng. When one of the route guidance content CTg and the lane change content CTc is being displayed, if a display request for the other occurs, the display generation unit 76 superimposedly displays the lane change content CTc in preference to the route guidance content CTg.

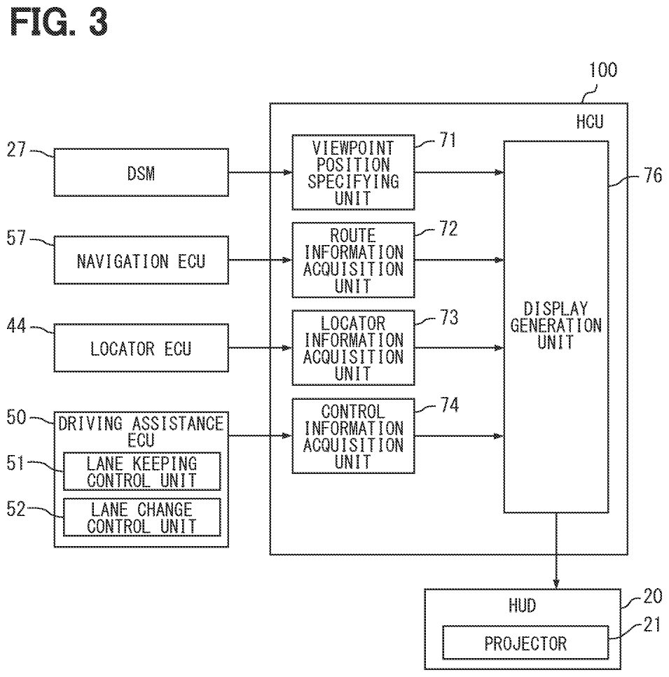

The details of such priority display will be described based on FIGS. 5 to 11 with reference to FIG. 3. In the following description, in a main lane on the road shown in FIGS. 5 to 11, a traveling lane adjacent to a guidance destination lane Lng is referred to as a first lane Ln1, and a traveling lane located opposite to the guidance destination lane Lng with respect to the first lane Ln1 is referred to as a second lane Ln2.

In the exit scene at the branch point shown in FIG. 5, the display generation unit 76 performs route guidance according to the remaining distance Dr from the vehicle A to a reference point GP. The reference point GP is a specific point defined in the high-precision map data of the guidance area GA. For example, at the branch point, the guidance destination lane Lng is a coordinate separated from the first lane Ln1, and an end of the boundary of the guidance destination lane Lng and the first lane Ln1 is generally set as the reference point GP. Such a reference point GP may be appropriately changed within the guidance area GA. Further, each threshold distance to be compared with the remaining distance Dr may be appropriately adjusted according to the position of the reference point GP in the guidance area GA.

In the display generation unit 76, a display request for the route guidance content CTg is generated at a guidance start point Pgs where the remaining distance Dr is less than a predetermined distance (for example, 2 km). When the vehicle A is traveling in the second lane Ln2, the display generation unit 76 superimposedly displays the route guidance content CTg on the road surface of the first lane Ln1 based on the display request (see the lower part of FIG. 5).

The route guidance content CTg is displayed in such a manner as to fill the road surface of the first lane Ln1. The route guidance content CTg is a superimposition content CTs that presents a range into which the driver should move the vehicle A. The display generation unit 76 updates the shape of the route guidance content CTg according to the road surface shape of the first lane Ln1 visually recognized in the angle of view VA.

After the display of the route guidance content CTg is started, when the on operation by the driver is input and the status information indicating the execution state of the LCA function is acquired by the control information acquisition unit 74, a display request of the lane change content CTc based on the LCA information is generated in the display generation unit 76. The lane change content CTc is a superimposition content CTs indicating the range of the road surface of the adjacent lane Lnd to which the vehicle is moved by the lane change. Therefore, the lane change content CTc has an aspect of filling the road surface of the first lane Ln1 in the same manner as the route guidance content CTg.

In the above case, a range of the lane change content CTc assumed to be superimposed on the first lane Ln1 overlaps with a range of the route guidance content CTg assumed to be superimposed on the first lane Ln1. The display generation unit 76 superimposedly displays the lane change content CTc in preference to the route guidance content CTg in the overlapping range of these contents. That is, the display generation unit 76 superimposedly displays the lane change content CTc on the road surface of the first lane Ln1, in place of the route guidance content CTg, based on the display request.

Specifically, the route guidance content CTg moves out of the angle of view VA as the vehicle A travels, and is hidden. On the other hand, the lane change content CTc enters the angle of view VA as the vehicle A travels, and is superimposedly displayed on the entire road surface of the first lane Ln1 (see the middle part of FIG. 5). During a transition period from the route guidance content CTg to the lane change content CTc, the display generation unit 76 adjusts the superimposed position of the route guidance content CTg by using the recognition information or the like acquired for the superimposed display of the lane change content CTc. As a result, the route guidance content CTg and the lane change content CTc are superimposedly displayed on the road surface of the first lane Ln1 in a state of being lined up along the first lane Ln1 without laterally shifting from each other.

The lane change content CTc moves downward (rearward) together with the road surface of the first lane Ln1 (adjacent lane Lnd) as the vehicle A travels. The display generation unit 76 updates the shape of the lane change content CTc to accord with the shape of the road surface of the first lane Ln1 visually recognized in the angle of view VA. The lane change content CTc is displayed in a display color or display brightness different from that of the route guidance content CTg, and is displayed in a mode to be more attractive than the route guidance content CTg.

In the case where the lane change content CTc is preferentially displayed, at least one of the navigation device 55 and the meter display continues the route guidance by the screen display. In addition, the display generation unit 76 displays a route guidance icon CTi in accordance with the frame out of the route guidance content CTg (see the upper part of FIG. 5).

The route guidance icon CTi is a non-superimposition content CTn including an arrow-shaped image portion and an outer peripheral image portion. The arrow-shaped image portion indicates the moving direction of the vehicle A at the branch point by the shape of bending toward the guidance destination lane Lng. The outer peripheral image portion surrounds the arrow-shaped image portion in an annular shape. The route guidance icon CTi is displayed at a position slightly below the center of the angle of view VA. If the subject vehicle lane Lns is linear, the route guidance icon CTi is superimposed on the road surface of the subject vehicle lane Lns when viewed from the driver.

When the lane change by the LCA function is completed, the display generation unit 76 recognizes whether or not the road surface of the guidance destination lane Lng is within the angle of view VA based on the simulation result of the display layout. When the display generation unit 76 superimposedly displays the lane change content CTc, the display generation unit 76 changes the mode of the priority display depending on whether or not the guidance destination lane Lng is within the angle of view VA. When the road surface of the guidance destination lane Lng is outside the angle of view VA, the display generation unit 76 temporarily hides the entire route guidance content CTg. On the other hand, when the road surface of the guidance destination lane Lng is within the angle of view VA, the display generation unit 76 continues the superimposed display of the route guidance content CTg on the road surface of the guidance destination lane Lng. This is to notify the driver that, after the lane change by the LCA function, the next lane change needs to be continuously performed.

An exit scene at a branch point shown in FIG. 6 is a scene in which a standby state for waiting for a lane change occurs after the superimposed display of the route guidance content CTg is started at the guidance start point Pgs. In this scene, another vehicle Ax, which hinders the lane change of the vehicle A to the first lane Ln1 (adjacent lane Lnd), is traveling in the first lane Ln1. The result of the peripheral check based on the on operation for activating the LCA function indicates the standby state of the LCA function due to the other vehicle Ax. In this case, the display generation unit 76 displays the standby content CTw and the standby icon CTwi (see the middle part of FIG. 6), in place of the route guidance content CTg displayed at the guidance start point Pgs (see the lower part of FIG. 6), based on the status information indicating the standby state of the LCA function.

The standby content CTw is a content that notifies the driver that the LCA function is in the standby state. The standby content CTw is superimposedly displayed on the road surface of the first lane Ln1, in place of the route guidance content CTg. The standby content CTw is displayed in preference to the route guidance content CTg, similarly to the lane change content CTc. The drawing shape of the standby content CTw is updated according to the shape of the road surface of the first lane Ln1 visually recognized in the angle of view VA, similarly to the route guidance content CTg and the like. The standby content CTw is displayed in a mode different from that of both the lane change content CTc and the route guidance content CTg. For example, the standby content CTw is displayed to blink in the same display color as the lane change content CTc.

The standby icon CTwi is a non-superimposition content CTn for notifying the existence of the other vehicle Ax, which is the cause of the standby state of the LCS function. The standby icon CTwi is displayed at a position corresponding to the relative position of the other vehicle Ax among the four corners of the angle of view VA. As an example, when the other vehicle Ax is traveling in parallel on the left rear side of the subject vehicle A, the standby icon CTwi is displayed at the lower left of the angle of view VA.

When the operation state indicated by the status information changes from the standby state to the execution state, the display generation unit 76 ends the display of the standby content CTw and the display of the standby icon CTwi. Then, the display generation unit 76 superimposedly displays the lane change content CTc on the road surface of the first lane Ln1, in place of the standby content CTw (see the upper part of FIG. 6). At this time, the display generation unit 76 may further display the route guidance icon CTi.

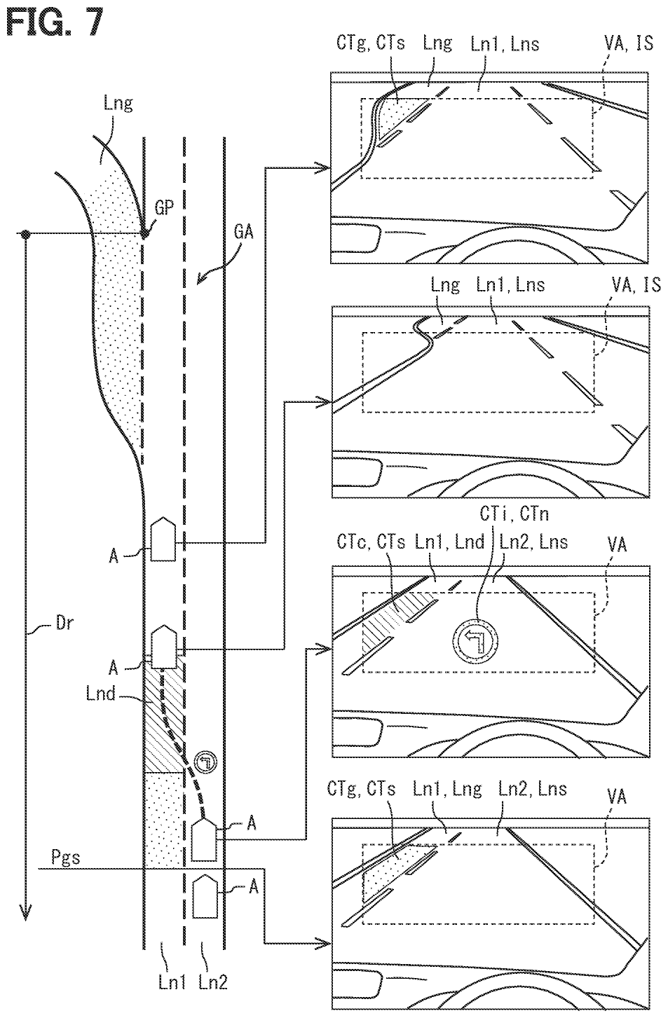

In an exit scene at a branch point shown in FIG. 7, the lane change from the second lane Ln2 to the first lane Ln1 is carried out immediately after the subject vehicle A passes the guidance start point Pgs. The display generation unit 76 changes the mode of a series of priority display in which the lane change content CTc is prioritized over the route guidance content CTg according to the remaining distance Dr to the reference point GP at which the route guidance is performed.

More specifically, in the vehicle A after changing lanes, since the guide destination lane Lng is far from the vehicle A, the guidance destination lane Lng is generally outside of the angle of view VA or is small enough to be visually recognized. Therefore, after the display generation unit 76 ends the display of the lane change content CTc, the display generation unit 76 waits for the display of the route guidance content CTg until the road surface of the guidance destination lane Lng is visually recognized in the angle of view VA with a sufficient size (see the middle upper part of FIG. 7). The display generation unit 76 starts the superimposed display of the route content on the road surface of the guidance destination lane Lng, based on the fact that the remaining distance Dr is reduced to a specific distance at which the guidance destination lane Lng is estimated large enough to be visually recognized (see the upper part of FIG. 7)

In this case, the display generation unit 76 may perform display control to change the mode of priority display according to the ratio of the area of the route guidance content CTg that can be displayed in the angle of view VA of the HUD 20, instead of the remaining distance Dr. More specifically, the display generation unit 76 can calculate the area ratio occupied by the range overlapping with the road surface of the guidance destination lane Lng, as viewed from the driver, of the entire range of the image plane IS (angle of view VA) based on the simulation result of the display layout. When the area ratio based on the simulation result is less than a predetermined threshold value (hereinafter, visual recognition threshold value), the display generation unit 76 waits for the superimposed display of the route guidance content CTg. Then, the display generation unit 76 starts the superimposed display of the route guidance content CTg when the area ratio becomes equal to or higher than the visual recognition threshold value. The visual recognition threshold value is, for example, an area ratio (for example, about 20%) at which the driver can perceive that the route guidance content CTg is superimposed on the road surface of the guidance destination lane Lng.

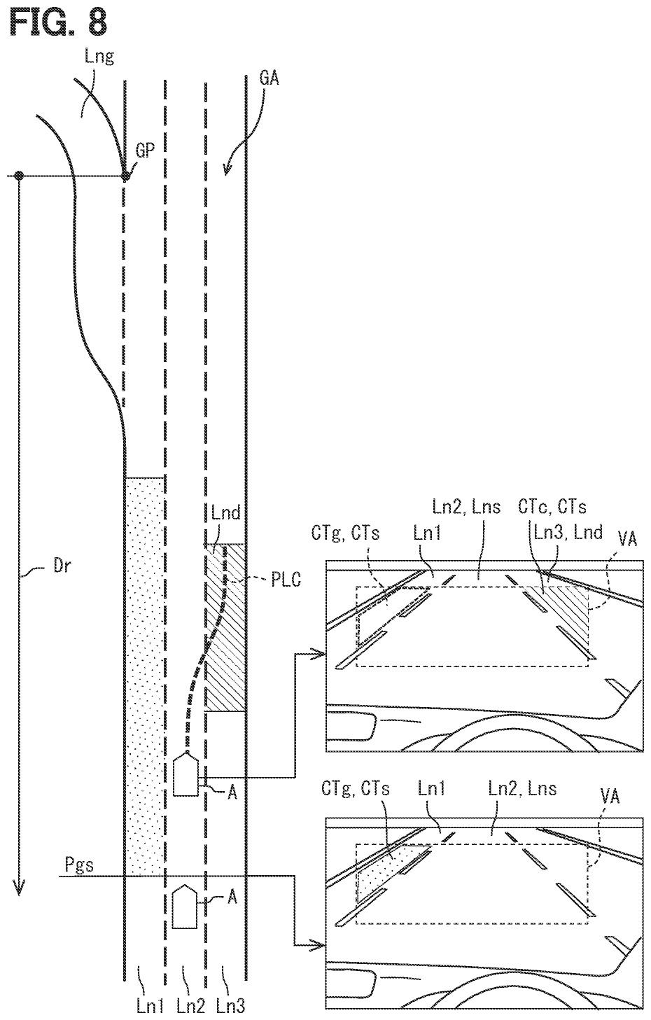

In a traveling scene shown in FIG. 8, the driver determines not to follow the route at the branch point indicated by the route information. The driver inputs an on operation instructing a lane change from the second lane Ln2 to the third lane Ln3. As a result, the moving direction indicated by the route information and the moving direction by the lane change control are different from each other. As described above, when the two movement directions do not coincide, the display generation unit 76 performs the priority display in which the lane change content CTc is further prioritized over the route guidance content CTg than when the two movement directions coincide with each other. Specifically, the display generation unit 76 immediately stops the display of the route guidance content CTg based on the display request of the lane change content CTc (see a range of a broken line). Then, the display generation unit 76 superimposedly displays the lane change content CTc on the road surface of the third lane Ln3 (adjacent lane Lnd).

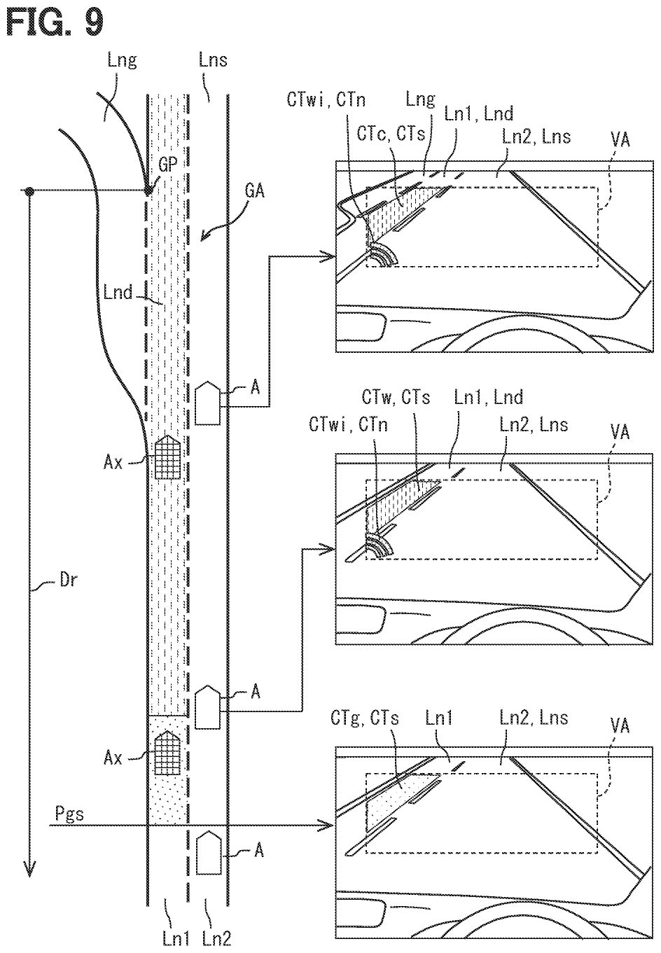

In traveling scenes shown in FIGS. 9 to 11, there is another vehicle Ax that hinders the lane change of the subject vehicle A to the first lane Ln1 (adjacent lane Lnd), as in the exit scene shown in FIG. 6. In this scene, it becomes difficult for the subject vehicle A to execute the lane change to the first lane Ln1 by the LCA function due to the existence of the other vehicle Ax, and thus the vehicle A passes through the reference point GP (guidance area GA) while keeping the traveling on the second lane Ln2.

As shown in FIG. 9, when the traveling of the second lane Ln2 is continued, the displays of the standby content CTw and the standby icon CTwi that are started by the on operation of the LCA function (see the middle part of FIG. 9) are kept until the vehicle A passes through the reference point GP (see the upper part of FIG. 9). In this case, the display generation unit 76 refrains the superimposed display of the route guidance content CTg on the guidance destination lane Lng even if the road surface of the guidance destination lane Lng is included in the angle of view VA.

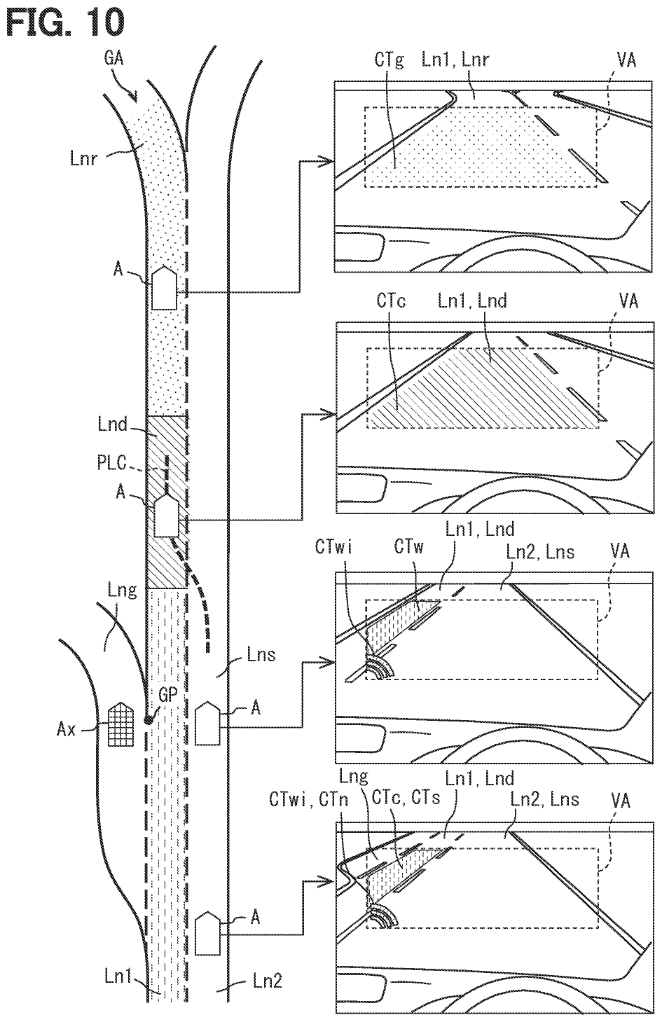

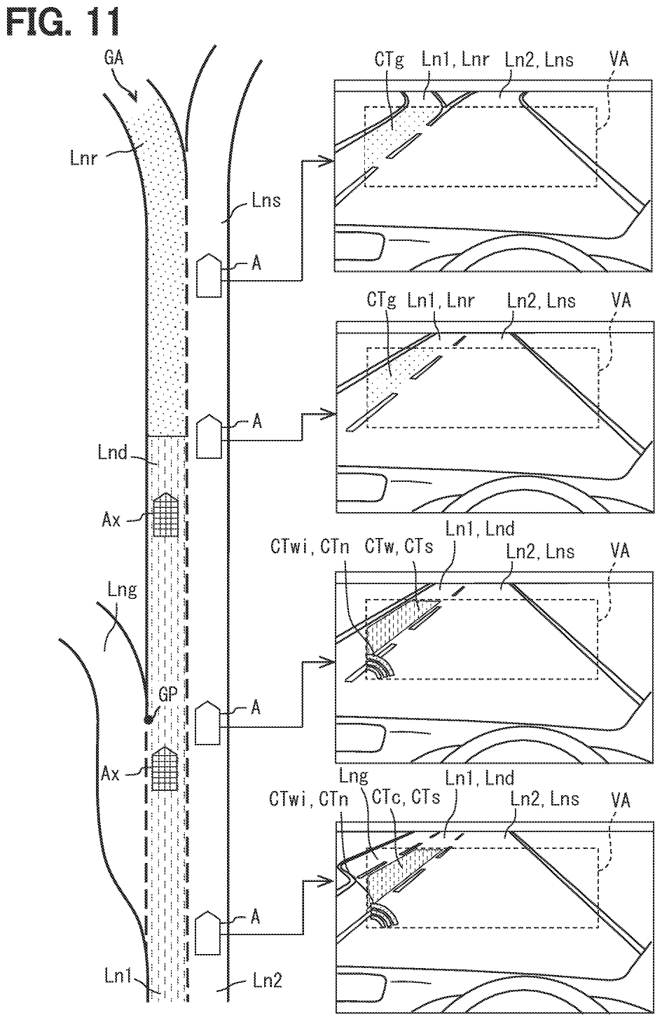

As shown in FIGS. 10 and 11, when the vehicle A passes through the reference point GP, the navigation ECU 57 determines that the vehicle A has deviated from the set route, and starts a reroute process for re-searching the route to the destination. In this case, a message indicating that the route is being rerouted, in other words, a message indicating that the route to the destination is being searched again is displayed on at least one of a screen of the navigation device 55 and a screen of the meter display. In addition, when the route to the destination is reset by the reroute process, a display guiding the new set route is started by at least one of the navigation device 55 and the meter display.

In the traveling scene shown in FIG. 10, the other vehicle Ax is separated from the first lane Ln1 just before the reference point GP. As a result, the lane change of the subject vehicle A to the first lane Ln1 by the LCA function is available in the vicinity of the reference point GP or after passing through the reference point GP. In this case as well, the display generation unit 76 superimposedly displays the lane change content CTc in preference to the route guidance content CTg.

Specifically, the display generation unit 76 does not notify the driver of the start of the reroute process by the navigation ECU 57 by displaying a virtual image. The display generation unit 76 suspends the display of the route guidance content CTg guiding the re-searched route in a period where the lane change control by the LCA function is in the standby state or being executed, even when the guidance execution request of the re-searched route is acquired by the route information acquisition unit 72. As described above, even if the reroute display by the navigation device 55 or the meter display is started after the vehicle A passes through the reference point GP, the display generation unit 76 continues to display the standby content CTw and the standby icon CTwi (see the lower middle part of FIG. 10).

When the operating state of the LCA function changes from the standby state to the execution state, the display generation unit 76 displays the lane change content CTc in place of the standby content CTw and the standby icon CTwi. At this time, the display generation unit 76 may further display the route guidance icon CTi (see FIG. 6). The display generation unit 76 continues the superimposed display of the lane change content CTc on the first lane Ln1 until the lane change of the vehicle A to the first lane Ln1 (adjacent lane Lnd) is completed (see the middle upper part of FIG. 10).

The display generation unit 76 starts displaying the route guidance content CTg that guides the re-searched route after the display of the lane change content CTc is completed. In a case where the guidance destination lane after the rerouting (hereinafter referred to as the re-guidance lane Lnr) exists ahead of the first lane Ln1 after the lane change, the display generation unit 76 displays the route guidance content CTg in the traveling direction (on a forward side) of the lane change content CTc (see the upper part of FIG. 10).

In the traveling scene shown in FIG. 11, the other vehicle Ax continues traveling in the first lane Ln1 even after passing through the reference point GP. As a result, the lane change of the subject vehicle A to the first lane Ln1 by the LCA function is stopped by a time-out at time where a predetermined time has elapsed from the on operation of the driver. Alternatively, the lane change of the subject vehicle A to the first lane Ln1 by the LCA function is canceled by the driver's cancel operation. Even in these cases, the display generation unit 76 superimposedly displays the lane change content CTc in preference to the route guidance content CTg.

Specifically, the display generation unit 76 suspends displaying the route guidance content CTg after the subject vehicle A passes through the reference point GP, even when the route information acquisition unit 72 acquires the guidance execution request of the re-searched route. The display generation unit 76 continues to display the standby content CTw and the standby icon CTwi (see the middle lower part of FIG. 11). Then, when the lane change is stopped by the time-out or the cancel operation, the display generation unit 76 ends the displays of the standby content CTw and the standby icon CTwi based on the status information indicating the off state of the LCA function. The display generation unit 76 displays the route guidance content CTg in place of the standby content CTw and the standby icon CTwi (see the middle upper part and the upper part in FIG. 11).

As an example, when the re-guidance lane Lnr exists ahead of the first lane Ln1, the display generation unit 76 switches the superimposition content CTs superimposed on the first lane Ln1 from the standby content CTw to the route guidance content CTg. In this case, the display generation unit 76 replaces the superimposition content CTs so that only one of the standby content CTw and the route guidance content CTg is displayed in the angle of view VA.

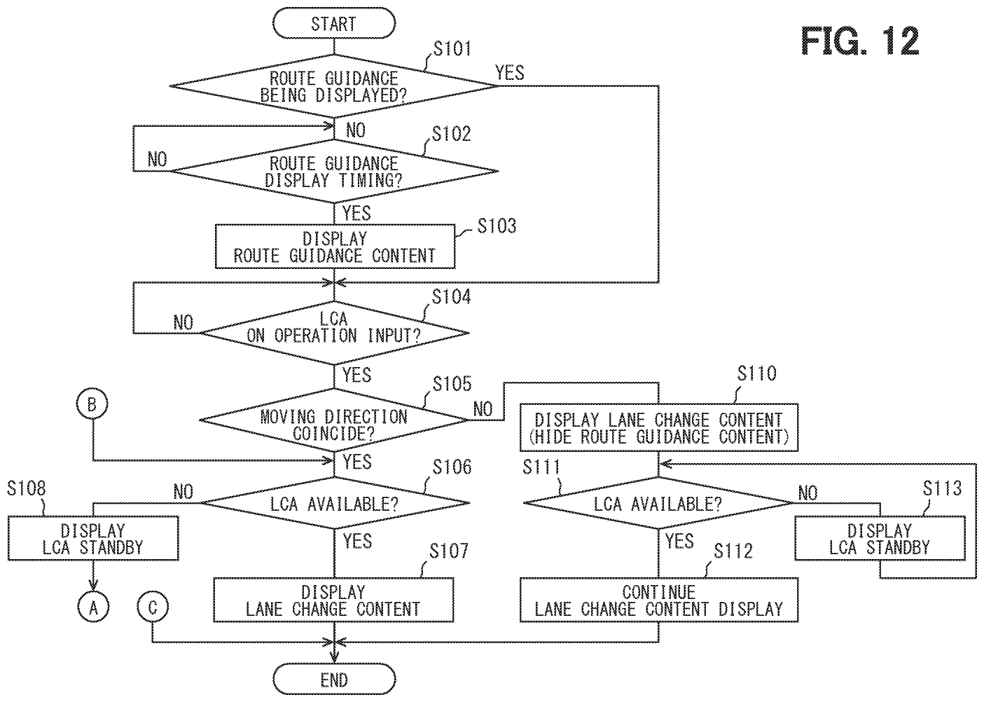

The details of a display control method for realizing the above display arbitration will be described hereinafter based on the flowcharts shown in FIGS. 12 to 14 with reference to FIGS. 5 to 11.

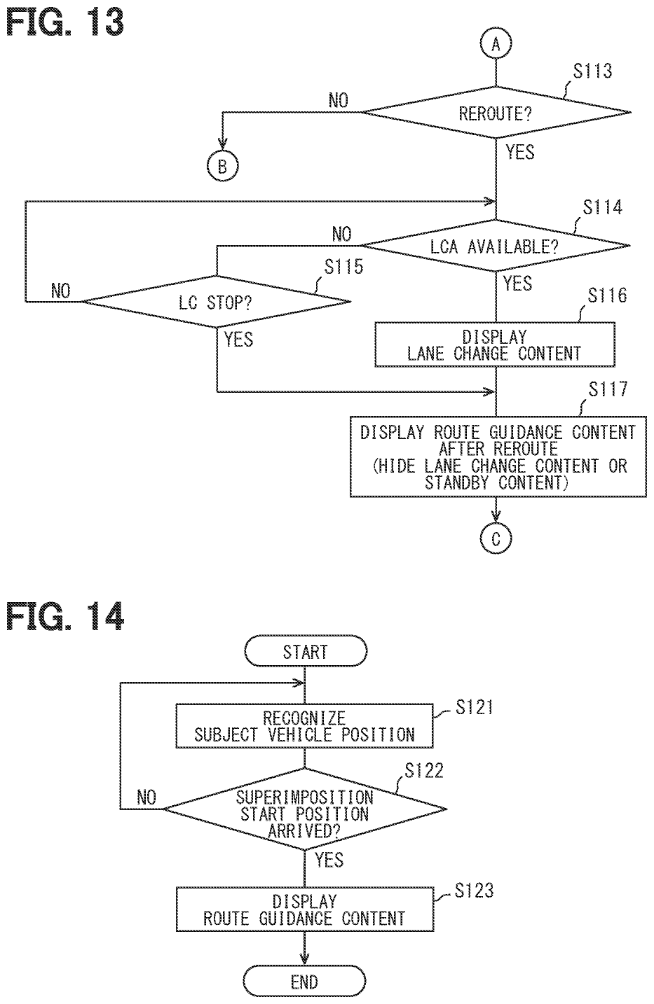

A display control process shown in FIGS. 12 and 13 is started by the HCU 100 that has received the guidance start request for the guidance area GA. Specifically, in S101, it is determined whether or not the route guidance display using the route guidance content CTg has already been performed. If it is determined in S101 that the route guidance display is being performed, the process proceeds to S104. On the other hand, if it is determined in S101 that the route guidance display has not been performed, the vehicle A waits for the vehicle A to reach the guidance start point Pgs in S102. Then, the process proceeds to S103. In S103, the superimposed display of the route guidance content CTg (see FIG. 5) is started, and the process proceeds to S104.

In S104, it is determined whether or not the on operation to turn on the LCA function is made based on the LCA information. If the on operation to turn on the LCA function is not made, the display of the route guidance content CTg is continued, and then the display control process is terminated based on the passage of the guidance area GA. On the other hand, if it is determined in S104 that the on operation to turn on the LCA function is made, the process proceeds to S105.

In S105, it is determined whether or not the direction of the route guidance and the direction of the lane change by the on operation coincide with each other, based on the route information acquired with the start of the present processing and the LCA information. If it is determined in S105 that the two moving directions coincide, the process proceeds to S106.

In S106, it is determined whether or not the LCA function is in the execution state based on the LCA information. If it is determined in S106 that the LCA function is in the execution state and the lane change is available, the process proceeds to S107. In S107, as the priority display of the lane change content CTc, the superimpose display of the lane change content CTc on the road surface of the adjacent lane Lnd, in place of the route guidance content CTg, is started (see FIG. 5), and the current display control process is terminated. In S107, the display of the route guidance icon CTi may be further started.

On the other hand, if it is determined in S106 that the LCA function is in the standby state and the lane change is unavailable, the process proceeds to S108. In S108, the superimposed display of the standby content CTw on the road surface of the adjacent lane Lnd, in place of the route guidance content CTg, is started (see FIG. 6), and the process proceeds to S113. In S108, the display of the standby icon CTwi is also started in accordance with the display of the standby content CTw.

In S113, it is determined whether or not the navigation ECU 75 has re-searched or reset the route by the retouring process. If it is determined in S113 that the route has not been reset by the navigation ECU 57 (no reroute), the process returns to S106. As described above, during the period in which the standby state of the LCA function is maintained by the lane change control unit 52, the standby content CTw and the standby icon CTwi are continuously displayed by repeating S106, S108, and S113. If the time-out occurs before the start of the reroute in the state where the LCA function is kept in the standby state, the current display control process may be terminated.

On the other hand, if it is determined in S113 that the route has been reset (by the rerouting process) by the navigation ECU 57, the process proceeds to S114. In S114, similarly to S106, it is determined whether or not the lane change by the LCA function is available based on the LCA information (status information). If it is determined in S114 that the standby state of the LCA function is continuing, the process proceeds to S115.

In S115, it is determined whether or not the lane change by the LCA function is stopped. If it is determined in S115 that the standby state of the LCA function is continuing, the process returns to S114. On the other hand, if it is determined that the lane change has been stopped due to the cancel operation or the time-out, the process proceeds to S117. In S117, a display transition from the standby content CTw to the route guidance content CTg indicating the route after the rerouting (see FIG. 11) is performed, and the current display control process is terminated.

On the other hand, if it is determined in S114 that the lane change is available, the process proceeds to S116. In S116, the display of the lane change content CTc is started, and the process proceeds to S117. In S117, a display transition is performed from the lane change content CTc to the route guidance content CTg indicating the route after the rerouting (see FIG. 10), and the current display control process is terminated.

If it is determined in S105 above that the moving directions do not coincide, the process proceeds to S110. In S110, the display of the route guidance content CTg is interrupted. Further, after starting the display of the lane change content CTc (see FIG. 8) and notifying that the on operation of the LCA function has been accepted, the process proceeds to S111. At this time, the standby content CTw and the standby icon CTwi may be displayed in place of the lane change content CTc.

In S111, similarly to S106, it is determined whether or not the lane change is available based on the LCA information. If it is determined in S111 that the lane change is unavailable, the process proceeds to S113. In S113, the display of the standby content CTw and the standby icon CTwi is started in the same manner as in S108. Also in this case, during the period in which the standby state is maintained, the display of the standby content CTw and the standby icon CTwi is continued by repeating S111 and S113.

On the other hand, if it is determined in S111 that the lane change is available, the process proceeds to S112. In S112, by continuing the display of the lane change content CTc, the execution of the lane change control is notified, and the current display control process is terminated.

A display control process shown in FIG. 14 is started by the display generation unit 76 based on the completion of the lane change control, and controls the timing of redisplaying the route guidance content CTg. Specifically, in S121, the relative position of the subject vehicle with respect to the reference point GP of the guidance area GA is recognized based on the locator information, the lane identification information, and the like, and the process proceeds to S122.

In S122, it is determined whether or not the vehicle A has reached the superimposition start point based on the position of the subject vehicle recognized in S121. In a case where the timing of redisplaying the route guidance content CTg is controlled based on the remaining distance Dr, it is determined in S122 that the vehicle A has reached the superimposition start point when the remaining distance Dr decreases to a specific distance. In a case where the timing of redisplaying the route guidance content CTg is controlled based on the area ratio of the route guidance content CTg, it is determined in S122 that the vehicle A has reached the superimposition start point when the area ratio becomes equal to or more than the visual recognition threshold value.

In S123, the route guidance content CTg is superimposedly displayed on the road surface of the guidance destination lane Lng (see FIG. 7), and the current display control process is terminated.

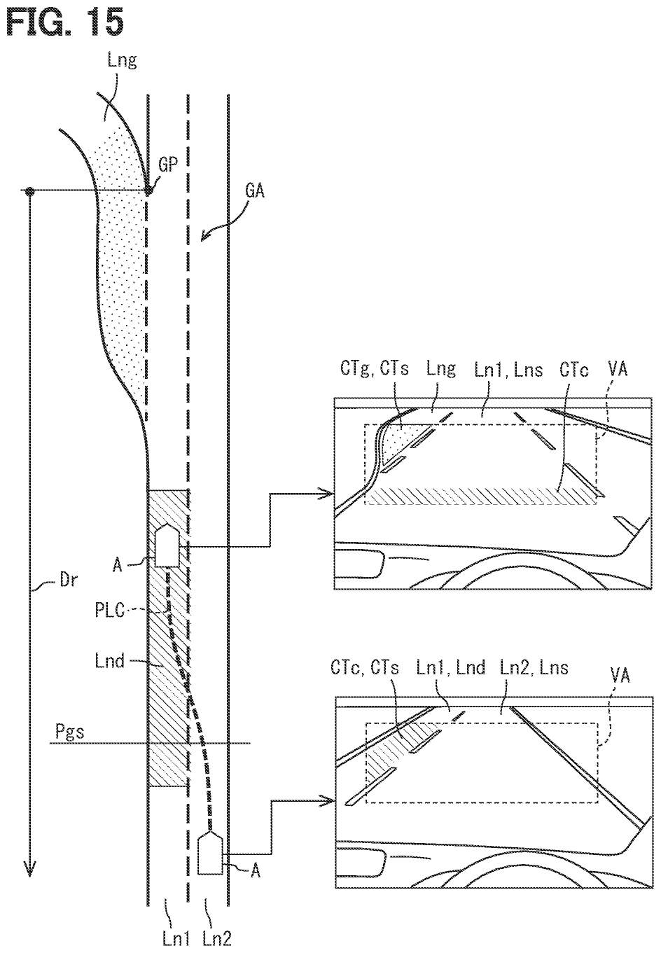

Further, FIG. 15 shows details of display transition of the display content when the on operation by the driver is input at a timing slightly earlier than the timing that the vehicle A reaches the guidance start point Pgs, in the same exit scene as in FIGS. 5 to 7. Even in such a case, the display generation unit 76 causes the lane change content CTc to be displayed in preference to the route guidance content CTg.

Specifically, when the display request for the route guidance content CTg occurs while the display generation unit 76 is displaying the lane change content CTc, the display generation unit 76 suspends the display of the route guidance content CTg. The display generation unit 76 waits for the start of display of the route guidance content CTg, and continues the superimposition display of the lane change content CTc. After the lane change is completed, the display generation unit 76 starts the superimposition display of the route guidance content CTg on the guidance destination lane Lng.

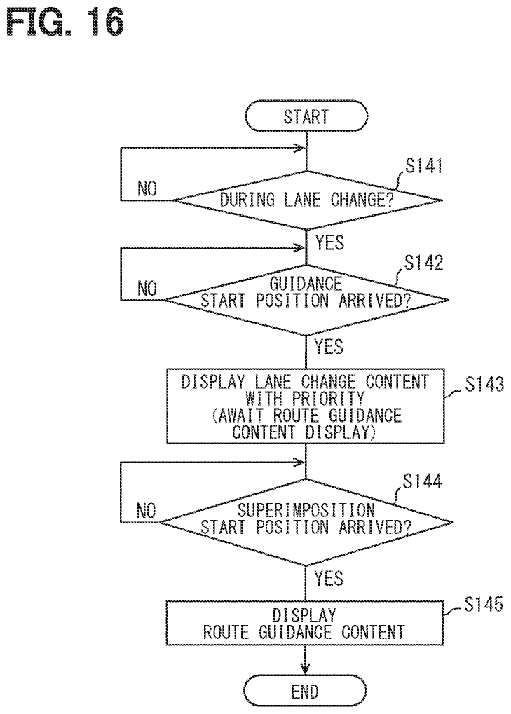

The details of the display control process for realizing the display arbitration in the above scene will be further described based on a flow chart shown in FIG. 16 with reference to FIG. 15. A display control process shown in FIG. 16 is started by the HCU 100 that has received the status information indicating the activation of the LCA function by the on operation.

In S141, it is determined whether or not the lane change by the LCA function is being executed based on the status information of the LCA function. In S142, it is determined whether or not the vehicle A has reached the guidance start point Pgs. According to the above S141 and S142, the process proceeds to S143 at a timing when the vehicle A reaches the guidance start point Pgs during the execution of the lane change.

In S143, the superimposed display is set to prioritize the lane change content CTc by waiting for the superimposition display of the route guidance content CTg, and the process proceeds to S144. In S144, as in S122, it is determined whether or not the vehicle A has reached the superposition start point based on the comparison between the remaining distance Dr and the specific distance or the comparison between the area ratio and the visual recognition threshold value. When it is determined in S144 that the vehicle A has reached the superimposition start point, the process proceeds to S145. In S145, the route guidance content CTg is superimposedly displayed on the road surface of the guide destination lane Lng, and the current display control process is terminated.

According to the first embodiment described so far, when the superimposed display of the route guidance content CTg and the superimposed display of the lane change content CTc are likely to overlap, the superimposed display of the lane change content CTc has priority over the superimposed display of the route guidance content CTg. According to the priority display of the lane change content CTc, it is possible to avoid a situation in which the recognition by the driver becomes difficult due to the two contents CTg and CTc both indicating the moving direction of the vehicle being displayed similarly. As a result, the content display easy for a driver to recognize is implemented.

In addition, in the first embodiment, when the movement direction indicated by the route information and the movement direction in the lane change control do not coincide with each other, the display generation unit 76 gives priority to the lane change content CTc over the route guidance content CTg in the superimposed display. Based on the above, it is possible to reliably avoid a situation in which the guidance in different directions is displayed simultaneously and equally, which confuses the driver.

In the first embodiment, when the two movement directions do not coincide, the route guidance content CTg is immediately hidden. As described above, in the priority display when the movement directions do not coincide, the route guidance content CTg is made less conspicuous than the priority display when the movement directions coincide. As described above, it is possible to surely avoid the situation where the display of the content contrary to the intention of the driver is annoying to the driver.

In the first embodiment, when it is assumed that the route guidance content CTg and the lane change content CTc superimposedly displayed on the first lane Ln1 overlap with each other in a range, the lane change content CTc is preferentially displayed in this range. According to the above, the lane change content CTc is superimposedly displayed on the road surface in a regular shape, and the content of vehicle control based on the driver's intention can be presented to the driver in an easy-to-understand manner.

In the first embodiment, the mode of the priority display is changed according to the remaining distance Dr or the ratio of the route guidance content CTg that can be displayed in the angle of view VA. Specifically, in a case where it is necessary to provide the route guidance to the guidance destination lane Lng which is adjacent to the movement destination lane after the lane change, when the remaining distance Dr to the reference point GP is long, the superimposed display of the route guidance content CTg on the guidance destination lane Lng is not started. On the other hand, when the remaining distance Dr to the reference point GP is short, the superimposed display of the route guidance content CTg on the guidance destination lane Lng is performed.

Alternatively, in a case where it is necessary to provide the route guidance to the guidance destination lane Lng which is adjacent to the movement destination lane after the lane change, when the route guidance content CTg cannot be displayed over the visual recognition threshold value in the angle of view VA, the superimposed display of the route guidance content CTg on the guidance destination lane Lng is not started. On the other hand, when the route guidance content CTg can be displayed over the visual recognition threshold value in the angle of view VA, the superimposed display of the route guidance content CTg on the guidance destination lane Lng is performed.

As described above, the display generation unit 76 executes the control that refrains the display of the route guidance content CTg until the subject vehicle A approaches sufficiently close to the guidance destination lane Lng. According to the above configuration, even if the route guidance content CTg is not given priority over the lane change content CTc, the function of presenting information to the driver in an easy-to-understand manner is ensured.

In addition, in the first embodiment, when the guidance execution request for a new set route is acquired by the route information acquisition unit 72 as the re-searched route information while waiting for the lane change control, the display of the route guidance content CTg for the re-searched route is suspended. As described above, even when the reroute occurs, if the contents CTc and CTw related to the lane change are preferentially displayed, the situation where the recognition of the contents display becomes difficult can be avoided.

In the first embodiment, after the display of the lane change content CTc or the standby content CTw is ended, the display of the route guidance content CTg for guiding the re-searched route is started. According to the above configuration, the driver can sequentially perform operations according to the content display. As a result, content display that is easy to recognize is realized even when the reroute occurs.

In the first embodiment, the superimposition position of the route guidance content CTg is adjusted according to the superimposition position of the lane change content CTc. Since the source of information is different between the route guidance content CTg and the lane change content CTc, the superimposition positions of the route guidance content CTg and the lane change content CTc are likely to be displaced. In order to avoid such displacement, recognition information with high position accuracy is used for positioning both the superimposition contents CTs. As a result, it is possible to avoid a situation in which the superimposition contents CTs that are each superimposed in association with the same superimposition target are displaced from each other and the contents are displayed with a sense of incongruity.

In addition, in the first embodiment, the superimposition position of the route guidance content CTg is adjusted by using the recognition information acquired for the superimposed display of the lane change content CTc. That is, the superimposition positions of both the lane change content CTc and the route guidance content CTg are set based on the recognition information used for the behavior control of the vehicle A. As described above, if the same information as the vehicle control is used for the generation of each superimposition content CTs, the displacement between the content display and the vehicle behavior is unlikely to occur. As a result, the discomfort of the content display can be reduced.

In the first embodiment, the first lane Ln1 corresponds to a “specific lane”, the remaining distance Dr corresponds to a “distance”, and the reference point GP corresponds to a “guidance point”. Further, the display generation unit 76 corresponds to a “display control unit”, and the HCU 100 corresponds to a “display control device”. In addition to the lane change content CTc, the standby content CTw also corresponds to the “lane change content”.

### Second Embodiment, and Third Embodiment

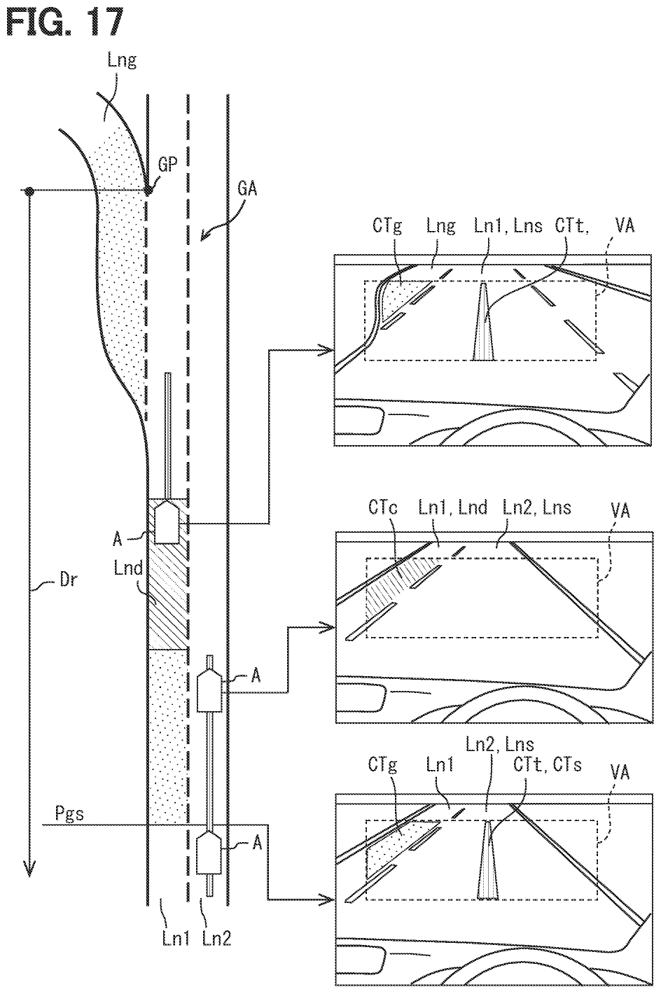

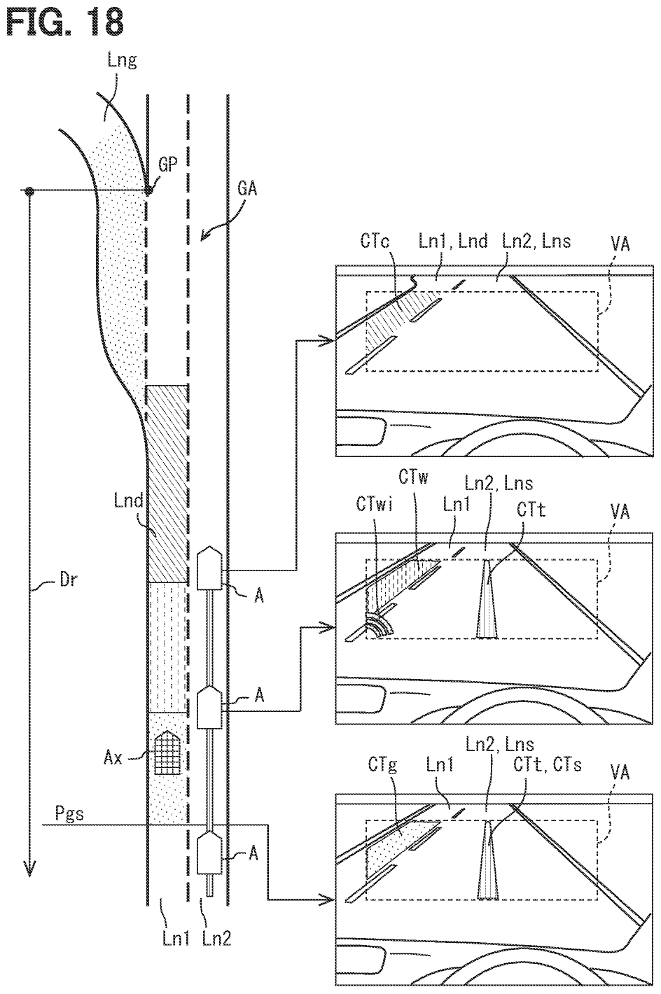

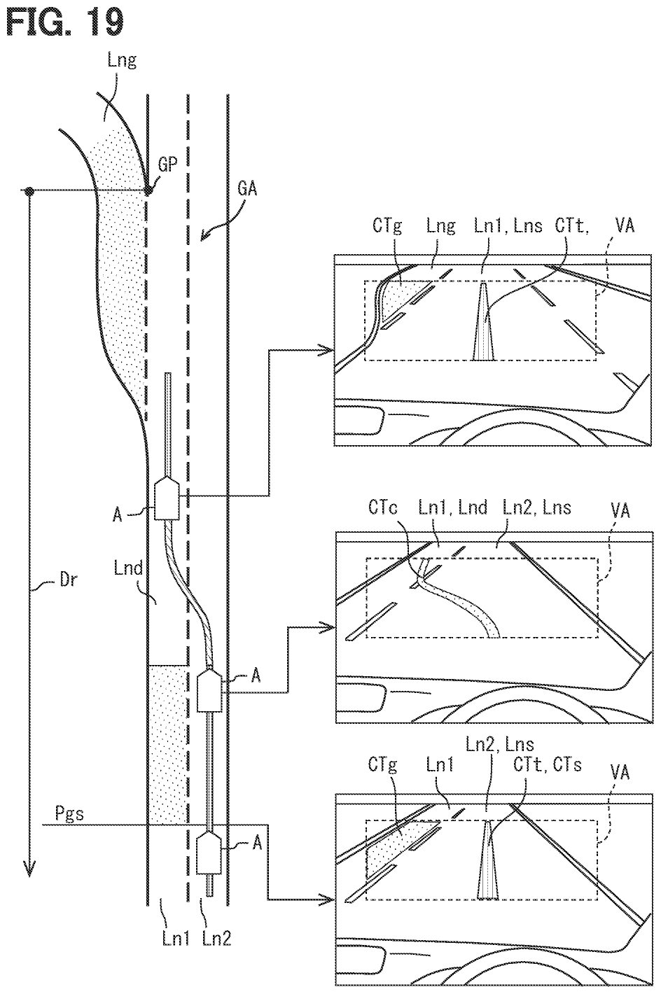

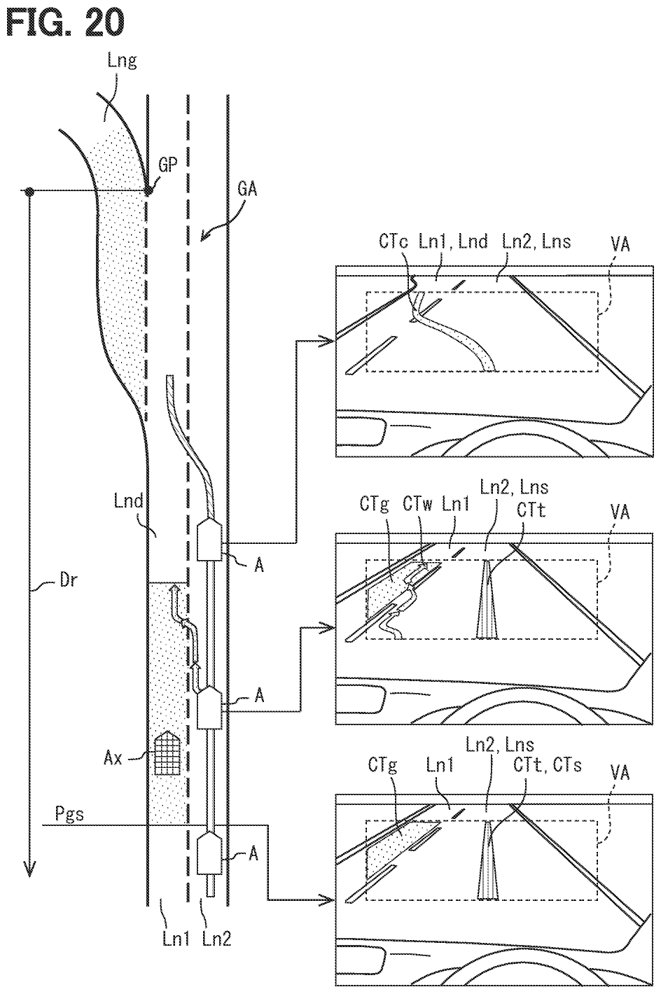

A second embodiment of the present disclosure shown in FIGS. 17 and 18 and a third embodiment of the present disclosure shown in FIGS. 19 and 20 are modifications of the first embodiment, respectively. In the second embodiment, an LTA execution content CTt is superimposedly displayed by the display generation unit 76 (see FIG. 3) in addition to the route guidance content CTg, the standby content CTw, and the lane change content CTc.

The LTA execution content CTt is a superimposed content CTs superimposedly displayed in the center of the road surface of the subject vehicle lane Lns in the foreground. The LTA execution content CTt is drawn in a strip shape and is displayed so as to stick to the road surface in an orientation along the road surface, thereby indicating an estimated trajectory of the in-lane traveling by the LTA function. Similar to the lane change content CTc, the drawing shape of the LTA execution content CTt is updated at a predetermined update cycle so as to match the shape of the road surface viewed from the eye point EP (see FIG. 2) as the vehicle A travels.

In the second embodiment, in the exit scene at the branch point shown in FIG. 17, the superimposition target of the route guidance content CTg is the road surface of the first lane Ln1, which is the guidance destination. On the other hand, the superimposition target of the LTA execution content CTt is the second lane Ln2 in which the subject vehicle is traveling. Therefore, when the vehicle A traveling in the lane by the LTA function reaches the guidance start point Pgs, the display generation unit 76 further displays the route guidance content CTg in addition to the LTA execution content CTt.

After the display of the route guidance content CTg is started, when a display request for the lane change content CTc is generated based on the on operation by the driver, the display generation unit 76 ends the display of the LTA execution content CTt. In addition, the display generation unit 76 starts the priority display of the lane change content CTc as in the first embodiment. Accordingly, the lane change content CTc is superimposedly displayed on the road surface of the adjacent lane Lnd, in place of the route guidance content CTg.

When the lane change by the LCA function is completed, the display generation unit 76 superimposedly displays the LTA execution content CTt on the road surface of the first lane Ln1 which has become the subject vehicle lane Lns. In addition, the display generation unit 76 superimposedly displays the route guidance content CTg on the road surface of the guidance destination lane Lng.

In an exit scene shown in FIG. 18, a lane change standby state due to another vehicle Ax occurs, as in the first embodiment (see FIG. 6). In this case, the display generation unit 76 performs the superimposed display of the standby content CTw on the adjacent lane Lnd in addition to the superimposed display of the LTA execution content CTt on the subject vehicle lane Lns. Further, the display generation unit 76 displays the standby icon CTwi in the lower left corner of the angle of view VA. The LTA execution content CTt ends the superimposed display with the transition from the standby state to the execution state of the LCA function. On the other hand, the content preferentially displayed on the first lane Ln1 is also changed from the standby content CTw to the lane change content CTc with the transition to the execution state of the LCA function.

In the third embodiment shown in FIGS. 19 and 20, the drawing shapes of the lane change content CTc and the standby content CTw are different from those in the second embodiment. The lane change content CTc and the standby content CTw are superimposed to extend over the road surface of the subject vehicle lane Lns and the road surface of the adjacent lane Lnd. The lane change content CTc is drawn in a strip shape extending so as to follow the lane change trajectory PLC (see FIG. 4). Also in the third embodiment, the lane change content CTc is preferentially displayed with respect to the route guidance content CTg, and is superimposedly displayed on the road surface of the adjacent lane Lnd from which the route guidance content CTg is hidden.

The standby content CTw is a content that can be displayed together with the route guidance content CTg and the LTA execution content CTt. When the LCA function is in the standby state, the standby content CTw is superimposedly displayed on the road surface of the own vehicle lane Lns together with the LTA execution content CTt. In addition, the tip portion of the standby content CTw is displayed to be superimposed on the route guidance content CTg.

Even in the second and third embodiments described so far, by the priority display of the lane change content CTc, it is possible to avoid a situation in which the recognition by the driver becomes difficult due to the two contents indicating the moving direction of the vehicle being displayed similarly. As a result, the content display easy for a driver to recognize is implemented.

### Fourth Embodiment

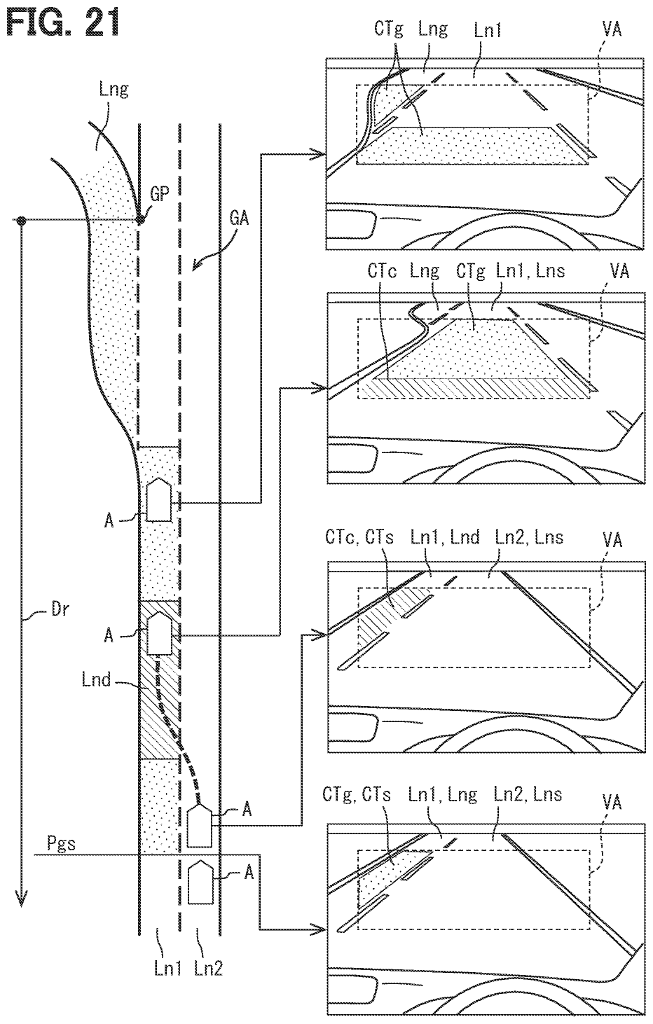

A fourth embodiment of the present disclosure shown in FIG. 21 is another modification of the first embodiment. In the first embodiment, after the lane change to the first lane Ln1 is started, the display generation unit 76 refrains the superimposed display of the route guidance content CTg on the first lane Ln1. The display generation unit 76 waits for the redisplay of the route guidance content CTg until the subject vehicle A reaches the superimposition start point (see S122 in FIG. 12). The display generation unit 76 superimposedly displays the route guidance content CTg on the road surface of the guidance destination lane Lng, after the subject vehicle A reaches the superimposition start point (see FIG. 7).

On the other hand, the display generation unit 76 of the fourth embodiment performs the priority display of the lane change content CTc even after the lane change to the first lane Ln1 is started, and further superimposedly displays the route guidance content CTg on the road surface of the first lane Ln1. As described above, when the display generation unit 76 superimposedly displays the lane change content CTc and the route guidance content CTg on the road surface of the same first lane Ln1, the superimposition range of the route guidance content CTg is set in a range ahead of the superimposition range of the lane change content CTc in the traveling direction. The range ahead in the traveling direction here refers to a range on the opposite side of the subject vehicle with respect to the lane change content CTc along the traveling lane. As described above, the lane change content CTc is preferentially superimposed on the road surface of the first lane Ln1 in a range in which the steering control by the LCA function is effective. On the other hand, the route guidance content CTg is continuously superimposedly displayed in a range of the road surface after the steering control by the LCA function is completed.

Also in the fourth embodiment described so far, by giving priority to the lane change content CTc, the content display that is easily recognized by the driver is realized. In addition, in the fourth embodiment, the superimposed display of the route guidance content CTg is performed in the road surface range in which the lane change content CTc is not superimposed. Therefore, even if the display of the lane change content CTc is prioritized, the easy-to-understand information presentation by the route guidance content CTg is ensured. In the fourth embodiment, the first lane Ln1 corresponds to the “traveling lane”.

### Fifth Embodiment

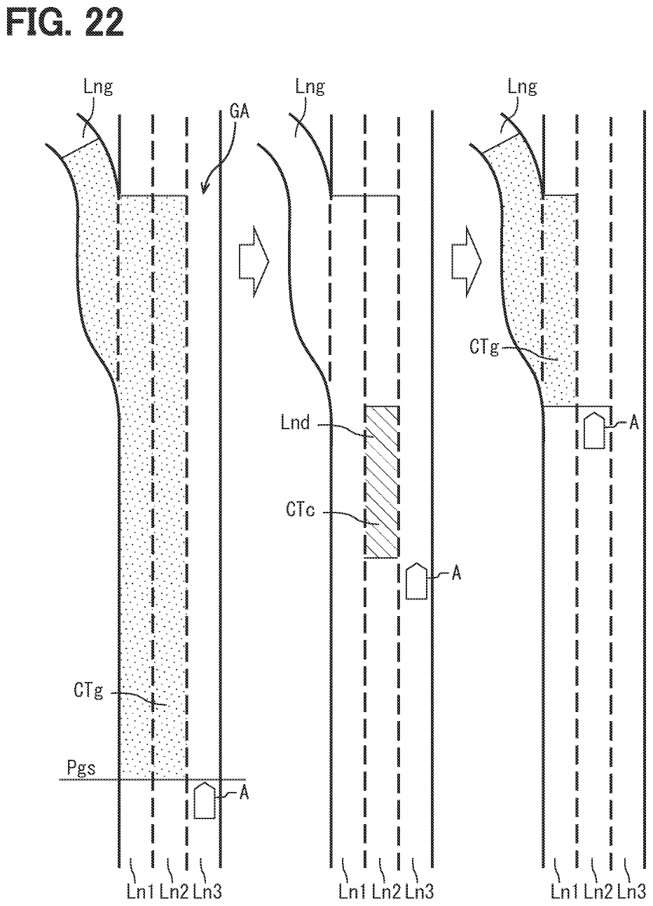

A fifth embodiment of the present disclosure is another modification of the first embodiment. In the fifth embodiment, the range of the road surface as the superimposition target of the route guidance content CTg is secured to be maximum. Specifically, in an exit scene shown in FIG. 22, when the vehicle A is traveling on the third lane Ln3, the superimposition target of the route guidance content CTg displayed when the subject vehicle A is at the guidance start point Pgs is not limited to the road surface of the second lane Ln2. The superimposition target of the route guidance content CTg is the road surface of each of the guidance destination lane Lng, the first lane Ln1 and the second lane Ln2. Similarly, when the vehicle A travels on the second lane Ln2, the superimposing target of the route guidance content CTg is the road surfaces of the guidance destination lane Lng and the first lane Ln1. As in the first embodiment, the superimposition target of the lane change content CTc is only the road surface of the adjacent lane Lnd (for example, the second lane Ln2).

In the fifth embodiment described so far, the range of the road surface on which the route guidance content CTg is superimposed is expanded to the maximum while not interfering with the superimposed display of the lane change content CTc. According to the above, even if the display of the lane change content CTc is prioritized, the easy-to-understand information presentation by the route guidance content CTg is ensured.

### Sixth Embodiment

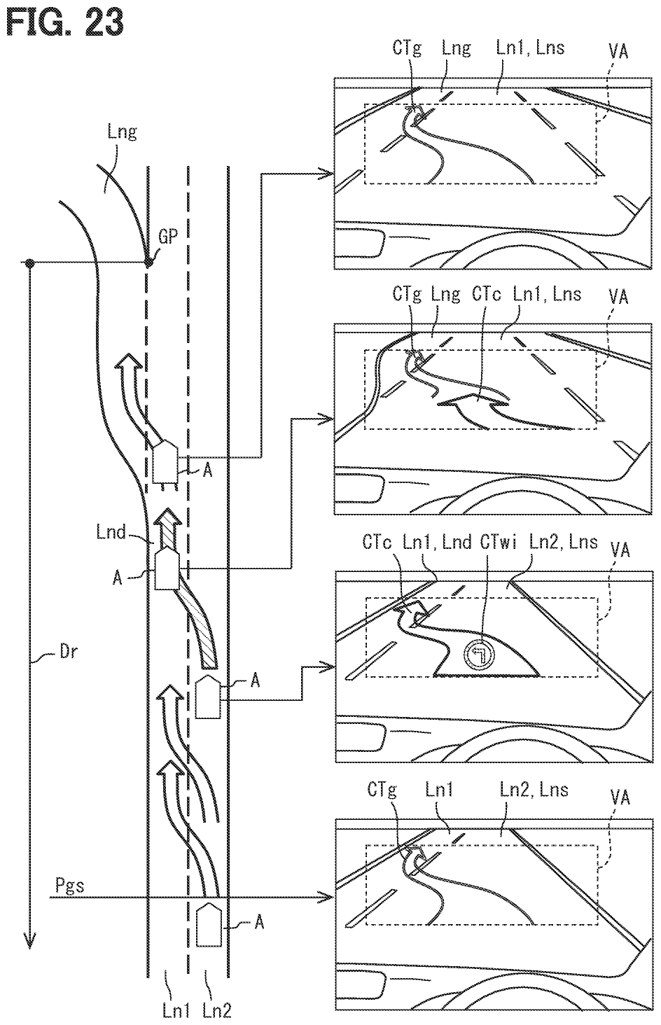

A sixth embodiment of the present disclosure illustrated in FIGS. 23 to 25 is still another modification of the first embodiment. In the sixth embodiment, the drawing shapes of the route guidance content CTg, the standby content CTw, and the lane change content CTc are different from those in the first embodiment. The route guidance content CTg, the standby content CTw, and the lane change content CTc are each drawn in the shape of an arrow indicating the traveling direction (moving direction) of the subject vehicle, and are superimposedly displayed to extend over the road surfaces of a plurality of (two) traveling lanes.

In an exit scene at a branch point shown in FIG. 23, the superimposed display of the route guidance content CTg is started at the guidance start point Pgs. The route guidance content CTg has an arrow shape extending from the second lane Ln2 to the first lane Ln1. The drawn shape of the route guidance content CTg is updated at a predetermined cycle as the vehicle A travels.

When a display request for the lane change content CTc is generated based on the driver's on operation, the displayed content transitions from the route guidance content CTg to the lane change content CTc. The lane change content CTc has an arrow shape extending from the subject vehicle lane Lns to the adjacent lane Lnd. Along with the start of display of the lane change content CTc, the display of the route guidance icon CTi is also started. However, the display of the route guidance icon CTi may be omitted.

When the lane change by the LCA function is executed and the guide destination lane Lng enters the angle of view VA, the route guidance content CTg is further displayed in the apparent traveling direction of the lane change content CTc. The route guidance content CTg has an arrow shape extending from the subject vehicle lane Lns after the lane change toward the guidance destination lane Lng. The lane change content CTc moves below in the angle of view VA as the vehicle A travels, and the display of the lane change content CTc is then terminated. As a result, the display transition from the lane change content CTc to the route guidance content CTg is completed.

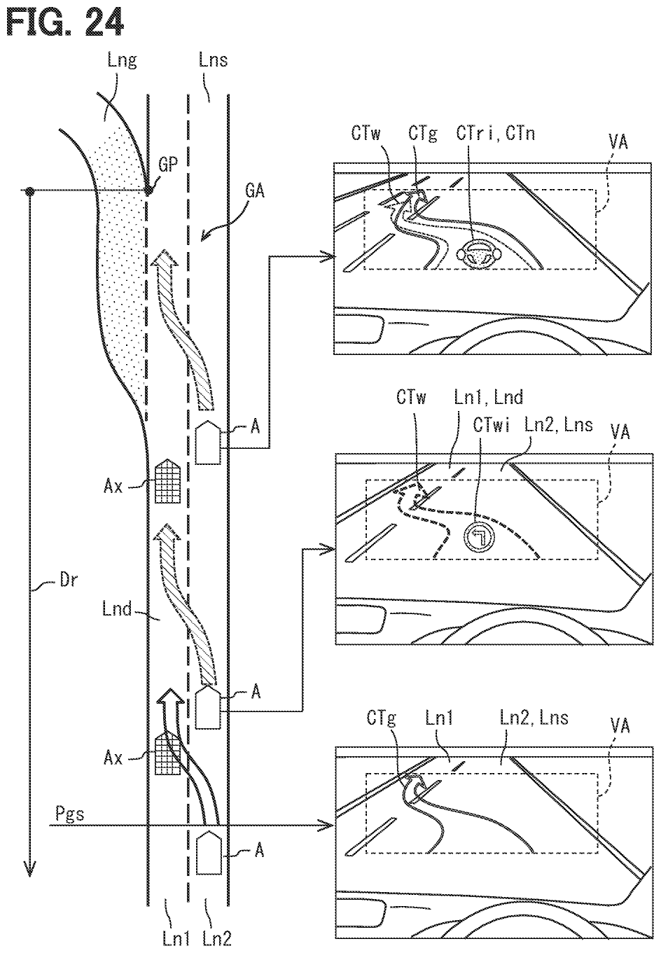

In an exit scene at a branch point shown in FIG. 24, a standby state of the lane change due to another vehicle Ax occurs after the superimposed display of the route guidance content CTg is started. In this case, the displayed content is transitioned from the route guidance content CTg to the standby content CTw. The standby content CTw has an arrow shape extending from the subject vehicle lane Lns toward the adjacent lane Lnd, similarly to the lane change content CTc (see FIG. 23). The standby content CTw has, for example, a broken line contour line so as to be distinguishable from the lane change content CTc. The display of the route guidance icon CTi may be started at the same time as the display of the standby content CTw is started.

If the standby state of the lane change due to the other vehicle Ax continues and it becomes difficult to execute the lane change by the LCA function due to the approach to the reference point GP, a request is made to transfer the operation right from the LCA function to the driver. The transfer of operation right is started at a predetermined position in front of the reference point GP in consideration of the remaining distance Dr or the remaining time to the reference point GP. In this case, the route guidance content CTg is displayed to be further superimposed on the standby content CTw. In addition, for example, a transfer request icon CTri that imitates the shape of the steering wheel is displayed as the non-superimposition content CTn below the center of the angle of view VA.

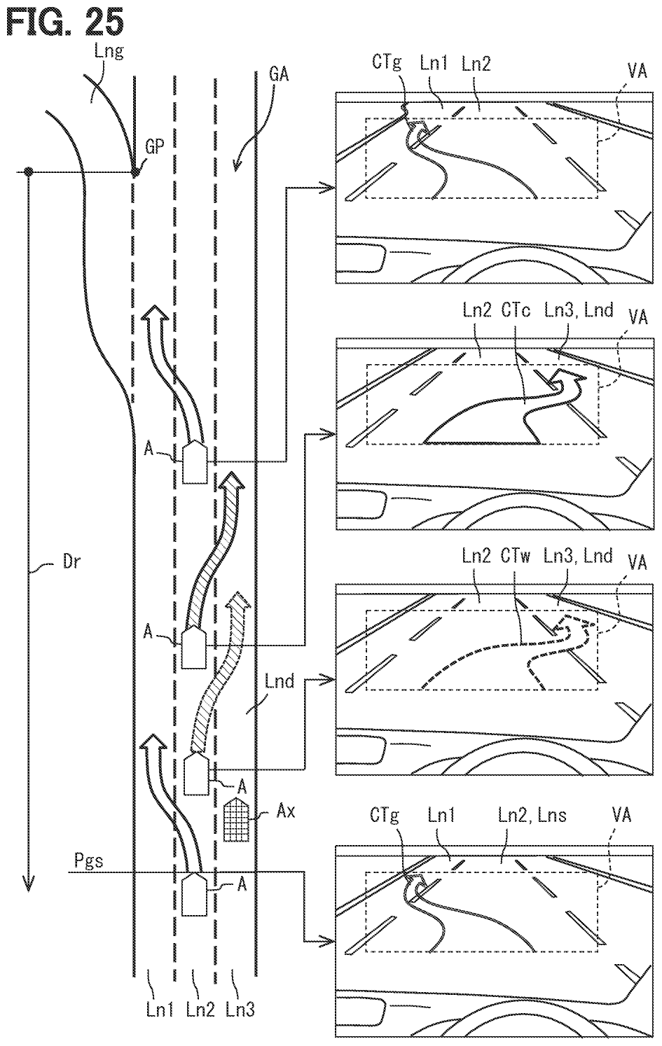

In a traveling scene shown in FIG. 25, a driver has determined that he/she does not follow the route at the branch point indicated by the route information, and inputs an on operation instructing the lane change from the second lane Ln2 to the third lane Ln3. In this case, in place of the arrow-shaped route guidance content CTg extending from the second lane Ln2 to the first lane Ln1, the arrow-shaped lane change content CTc extending from the second lane Ln2 to the third lane Ln3 is displayed. However, in a case where the LCA function is in the standby state due to the other vehicle Ax (see FIG. 9, S111: NO), the standby content CTw is displayed. Similar to the lane change content CTc, the standby content CTw has an arrow shape extending from the second lane Ln2 to the third lane Ln3, and the outline is drawn with a broken line. Then, when the LCA function transitions from the standby state to the execution state, the displayed content is switched from the standby content CTw to the lane change content CTc. In a case where the movement direction indicated by the route information and the movement direction in the lane change control are different from each other, the display of the standby icon CTwi is also omitted.

Further, in a case where the driver cancels the instruction of the lane change in a direction different from the movement direction indicated by the route information by the cancel operation, the display of the lane change content CTc is terminated. In this case, in place of the lane change content CTc, the route guidance content CTg extending from the second lane Ln2 to the first lane Ln1 is redisplayed.

Even in the mode of presenting information using the arrow-shaped superimposed content CTs as in the sixth embodiment described so far, if the lane change content CTc is preferentially displayed, the content display that is easily recognized by the driver is realized.

### Seventh Embodiment

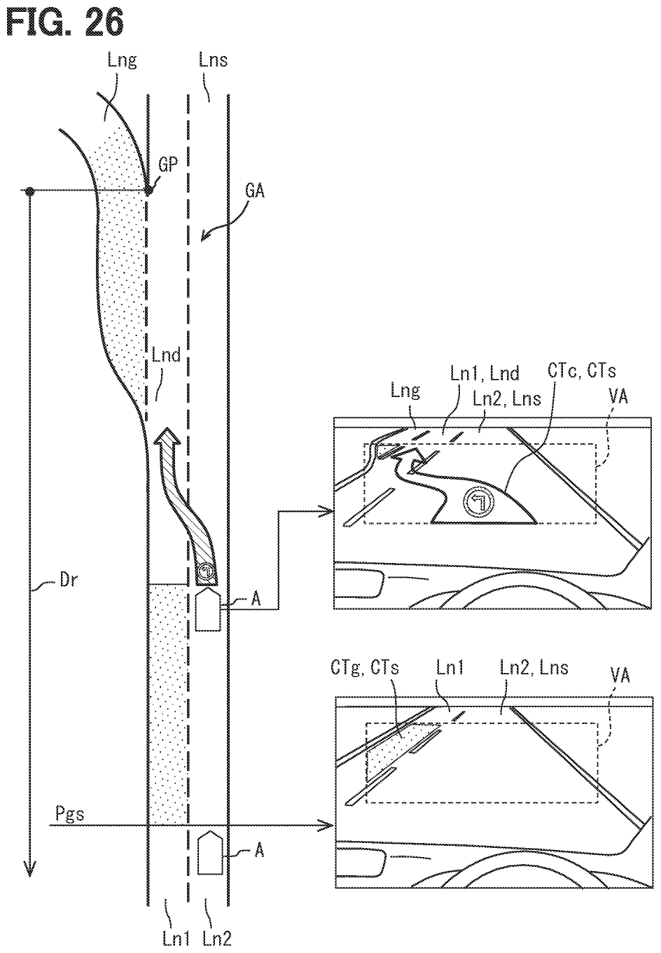

A seventh embodiment of the present disclosure illustrated in FIG. 26 is yet another modification of the first embodiment. Similar to the first embodiment, the route guidance content CTg of the seventh embodiment is superimposedly displayed on the road surface of the adjacent lane Lnd (first lane Ln1) in such a manner as to fill the road surface. On the other hand, the lane change content CTc is superimposed over both the road surfaces of the subject vehicle lane Lns and the adjacent lane Lnd, and has an arrow shape extending from the subject vehicle lane Lns toward the adjacent lane Lnd, as in the sixth embodiment.

Also in the seventh embodiment described above, the display transition is carried out in which the route guidance content CTg is hidden and the lane change content CTc is preferentially displayed in the section where the lane change is performed based on the driver's on operation. As described above, even when the superimposition content CTs having different drawing shapes are combined, the display arbitration that gives priority to the lane change content CTc realizes the content display that is easily recognized by the driver.

### Eighth Embodiment

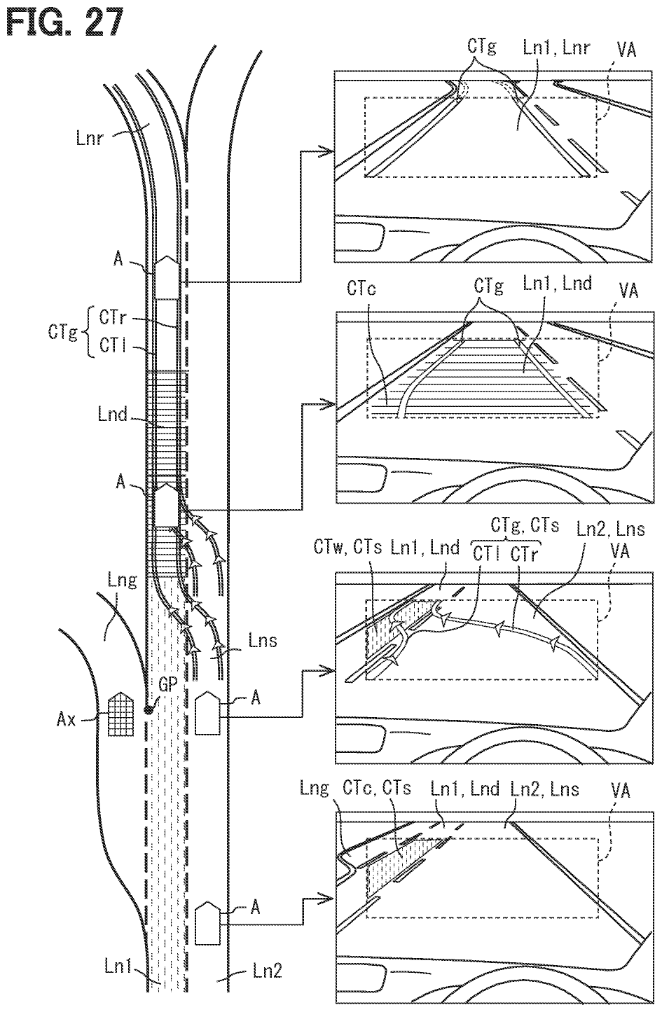

An eighth embodiment of the present disclosure shown in FIGS. 27 to 29 is still another modification of the first embodiment. In the eighth embodiment, the drawing shape of the route guidance content CTg is different from that of the first embodiment. The route guidance content CTg includes a left boundary line CTl and a right boundary line CTr, and is superimposedly displayed across the road surfaces of a plurality of (two) traveling lanes. Each boundary line CTl and CTr has a drawing shape extending in a strip shape in the direction of destination based on the route information. Specifically, the left boundary line CTl extends from the vicinity of the left lane marking line of the subject vehicle lane Lns to the vicinity of the left lane marking line of the adjacent lane Lnd. The right boundary line CTr extends from the vicinity of the right lane marking line of the subject vehicle lane Lns to the vicinity of the right lane marking line of the adjacent lane Lnd.

The display generation unit 76 does not suspend the display of the route guidance content CTg that guides the re-searched route when the re-searched route information is acquired by the control information acquisition unit 74 while waiting for the lane change control. The display generation unit 76 displays the route guidance content CTg indicating the route information after rerouting, together with the standby content CTw or the lane change content CTc.

Specifically, in a traveling scene shown in FIG. 27, as in the first embodiment (see FIG. 10), the vehicle A whose lane change to the first lane Ln1 is hindered by the other vehicle Ax is passing through the reference point GP while traveling in the second lane Ln2. As a result, the navigation ECU 57 determines that the vehicle A has deviated from the set route, and starts the reroute process of re-searching the route to the destination. As a result, the navigation ECU 57 notifies the route information acquisition unit 72 of the guidance execution request of the re-searched route guidance.

The display generation unit 76 starts displaying the route guidance content CTg that guides the re-searched route based on the guidance execution request acquired as the route information by the route information acquisition unit 72. The display generation unit 76 superimposes each of the boundary lines CTl and CTr on the upper side of the standby content CTw or the lane change content CTc on the appearance of the driver (see FIG. 27, middle lower part and middle upper part). The display generation unit 76 adjusts the superimposition position of each of the boundary lines CTl and CTr according to the superimposition position of the standby content CTw or the lane change content CTc by using the lane identification information.

The display generation unit 76 continues to display the boundary lines CTl and CTr superimposed on the lane change content CTc until the lane change to the first lane Ln1 (adjacent lane Lnd) is completed after the start of the lane change by the LCA function. Based on the completion of the lane change by the LCA function, the display generation unit 76 ends the display of the lane change content CTc while continuing to display the boundary lines CTl and CTr that guide the route to the re-guidance lane Lnr.

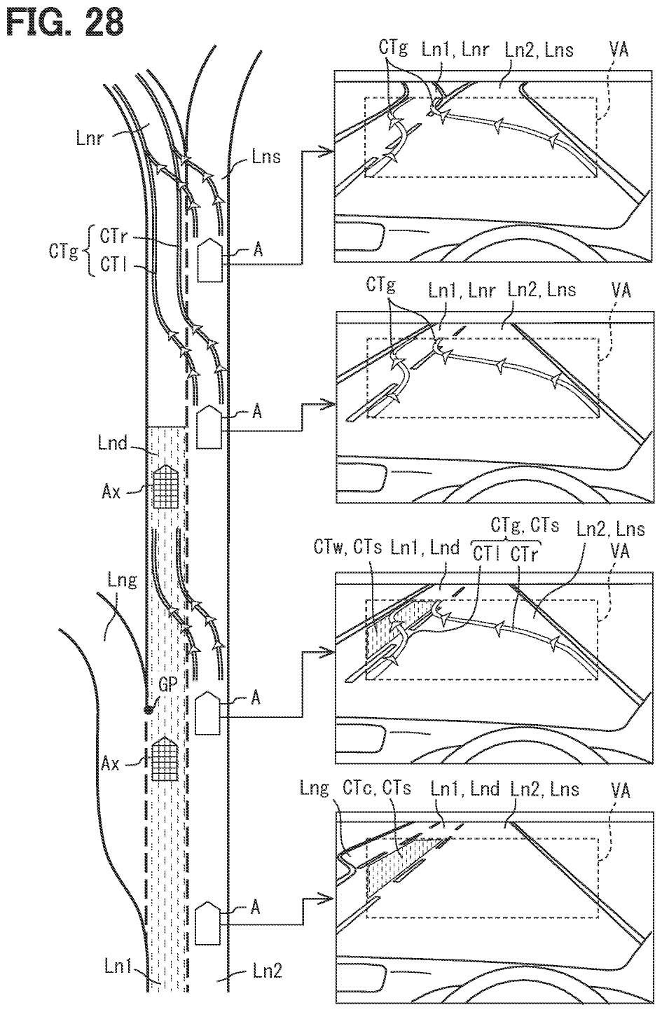

On the other hand, in a traveling scene shown in FIG. 28, it is difficult for the subject vehicle A to execute the lane change to the first lane Ln1 by the LCA function due to the other vehicle Ax even after passing the reference point GP. Even in such a traveling scene, the display generation unit 76 starts displaying the route guidance content CTg that guides the re-searched route based on the acquisition of the guidance execution request by the route information acquisition unit 72. Each of the boundary lines CTl and CTr of the route guidance content CTg is displayed to be superimposed on the standby content CTw (see the middle lower part of FIG. 28).

The display generation unit 76 ends the display of the standby content CTw based on the status information indicating the off state of the LCA function when the lane change is canceled due to the timeout or the cancel operation (see the middle upper part of FIG. 28). Also in this case, the display generation unit 76 continues to provide the route guidance to the re-guidance lane Lnr by continuing to display the boundary lines CTl and CTr extending from the subject vehicle lane Lns to the adjacent lane Lnd (see the upper part of FIG. 28).

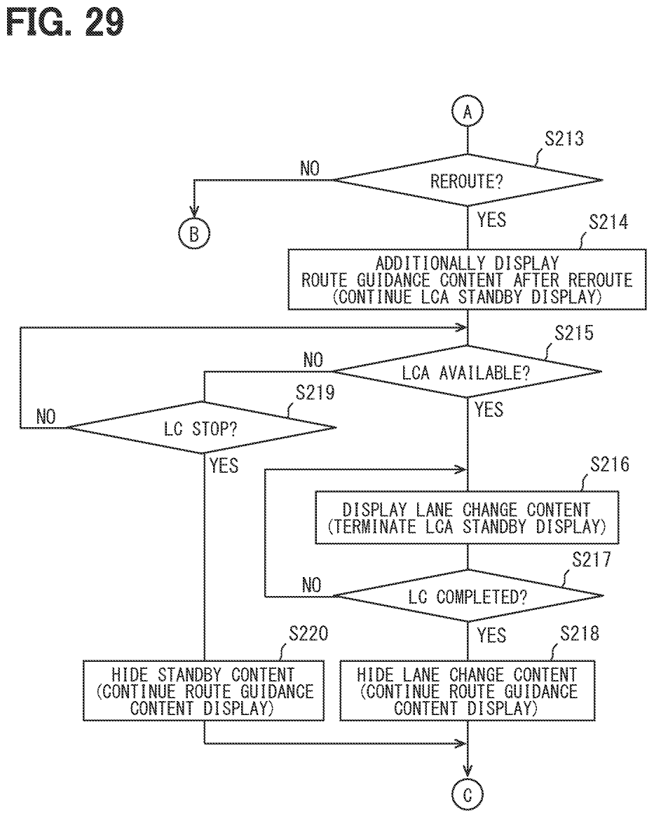

The details of the display control method described above for realizing the display arbitration after passing the reference point GP will be described below based on the flowchart shown in FIG. 29 with reference to FIGS. 12, 27 and 28.

Similar to S113 (see FIG. 13) of the first embodiment, S213 is performed after the start of the superimposed display of the standby content CTw (see FIG. 12, S108). In S213, it is determined whether or not the route has been re-searched and reset by the navigation ECU 57. When it is determined in S213 that the route has not been reset by the navigation ECU 57, the process returns to S106.

On the other hand, when it is determined in S213 that the route has been reset by the navigation ECU 57, the process proceeds to S214. In S214, the route guidance content CTg that guides the set route after the reroute process is additionally displayed, and the process proceeds to S215.

In S215, as in S106, it is determined whether or not the lane change by the LCA function is available based on the LCA information. When it is determined in S215 that the lane change is available, the process proceeds to S216.

In S216, the lane change content CTc is displayed in place of the standby content CTw, and the process proceeds to S217. In S217, it is determined whether or not the lane change by the LCA function has been completed. When it is determined in S217 that the lane change is continuing, the process returns to S216. As described above, the display of the lane change content CTc continues until the lane change is completed.

On the other hand, when it is determined in S217 that the lane change has been completed, the process proceeds to S218. In S218, the lane change content CTc is hidden while the display of the route guidance content CTg is continued, and the current display control process is terminated.

When it is determined in S215 that the standby state of the LCA function is continuing, the process proceeds to S219. In S219, it is determined whether or not the lane change is stopped due to the cancel operation or the timeout. When it is determined in S219 that the lane change is stopped, the process returns to S215.

On the other hand, when it is determined in S219 that the lane change is stopped, the process proceeds to S220. In S220, the standby content CTw is hidden while the display of the route guidance content CTg is continued, and the current display control process is terminated.

Even in the eighth embodiment described so far, the priority display of the lane change content CTc is performed until the subject vehicle A arrives the reference point GP. Therefore, the same effects as those of the first embodiment are obtained, and the content display that is easily recognized by the driver is realized.

In addition, in the eighth embodiment, when the re-searched route information is acquired by the route information acquisition unit 72 while waiting for the lane change control, the route guidance content CTg for guiding the re-searched route is displayed together with the standby content CTw. According to the above, the rerouted route information can be notified to the driver at an early stage by displaying the route guidance content CTg.

### Other Embodiments

Although the plurality of embodiments and modifications of the present disclosure have been described hereinabove, the present disclosure is not construed as being limited to the above embodiments and modifications, and various embodiments and combinations thereof are applicable without departing from the gist of the present disclosure.

In the embodiment described above, the lane change content CTc is displayed in preference to the route guidance content CTg by the arbitration to hide the entire route guidance content CTg or the part of the route guidance content CTg overlapping with the lane change content CTc based on the display request of the lane change content CTc. However, the mode of the priority display may be changed as appropriate. For example, in the embodiments described above, the display transition for switching from the route guidance content CTg to the route guidance icon CTi as the non-superimposition content CTn also corresponds to the priority display of the lane change content CTc.

Further, the priority display may be performed in such a way that the lane change content CTc is highlighted more than the route guidance content CTg after displaying both the lane change content CTc and the route guidance content CTg. The highlighting of the lane change content CTc may be made by a static differentiation, such as by increasing the display color brightness or the display brightness of the lane change content CTc relative to the route guidance content CTg, or by making the display color of the lane change content CTc a highly attractive color.

In addition, the highlighting of the lane change content CTc may be made by a dynamic differentiation, such as by displaying only the lane change content CTc in animation among the lane change content CTc and the route guidance content CTg. Further, the portion relatively highlighted by the static or dynamic differentiation may be the entire lane change content CTc, or may be the part of the lane change content CTc that overlaps with the route guidance content CTg.

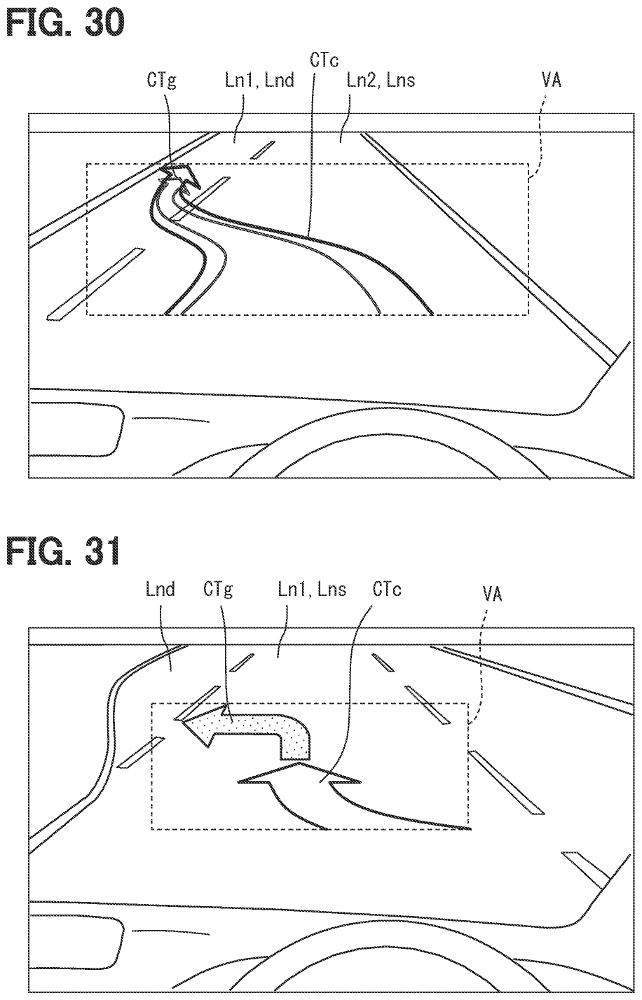

Specifically, in a first modification shown in FIG. 30, which is a modification of the embodiments described above, the lane change content CTc is displayed to be superimposed on the route guidance content CTg. The lane change content CTc is displayed, for example, as an animation that repeatedly flows from the subject vehicle lane Lns to the adjacent lane Lnd, or is displayed blinking. At this time, the animation display of the route guidance content CTg is not performed. As in the first modification described above, if the two contents CTg and CTc are dynamically differentiated by the addition of the animation, the two contents CTg and CTc may be superimposedly displayed on the same road surface range in a state of being overlapped with each other.

In a second modification shown in FIG. 31 of the embodiments described above, the angle of view VA of the HUD is narrower than that of the embodiment described above. In the second modification, therefore, the range of the road surface included in the angle of view VA is almost only the road surface of the subject vehicle lane Lns in terms of appearance from the driver. Therefore, the route guidance content CTg and the lane change content CTc are superimposedly displayed on the road surface of the subject vehicle lane Lns, and indicate the direction of the guidance destination lane Lng or the adjacent lane Lnd as the movement direction. The route guidance content CTg is superimposedly displayed on the road surface of the subject vehicle lane Lns so as to avoid the lane change content CTc because of the priority display of the lane change content CTc. As a result, the route guidance content CTg is superimposedly displayed in the traveling direction of the lane change content CTc.

In the embodiment described above, the display generation unit 76 gives priority to the lane change content CTc to be superimposedly displayed on the road surface over the route guidance content CTg regardless of whether or not the movement direction indicated by the route information and the movement direction in the lane change control coincide with each other. However, in a third modification of the embodiments described above, the priority display of the lane change content CTc is performed only when the two moving directions do not coincide with each other As in the third modification, the priority display of the lane change content CTc may be limitedly performed under specific conditions.

In a fourth modification of the embodiments described above, the priority display in which the lane change content CTc is prioritized over the route guidance content CTg is not changed according to the remaining distance Dr to the guidance area GA or the reference point GP where the route guidance is performed. That is, even if the remaining distance Dr is longer than the specific distance, or even if the area ratio of the route guidance content CTg is lower than the visual recognition threshold value, the superimposed display of the route guidance content CTg on the guide destination lane Lng is performed.

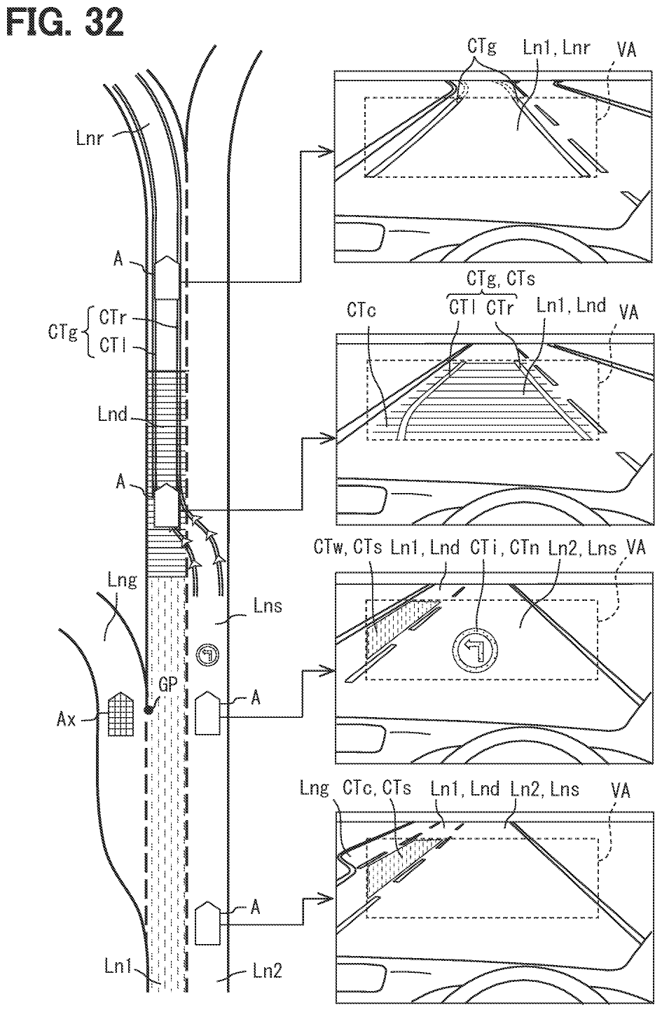

In a fifth modification shown in FIG. 32, as a modification of the eighth embodiment, the route guidance icon CTi as the non-superimposition content CTn is displayed based on the acquisition of the guidance execution request after the reroute process (see the middle lower part of FIG. 32). In other words, the display of the route guidance content CTg, which is the superimposition content CTs, is temporarily suspended. Based on the transition to the execution state of the LCA function, the display generation unit 76 also executes the display transition from the route guidance icon CTi to the route guidance content CTg in accordance with the display transition from the standby content CTw to the lane change content CTc. As described above, the boundary lines CTl and CTr are displayed on the road surface of the adjacent lane Lnd so as to overlap the lane change content CTc (see the middle upper part of FIG. 32).

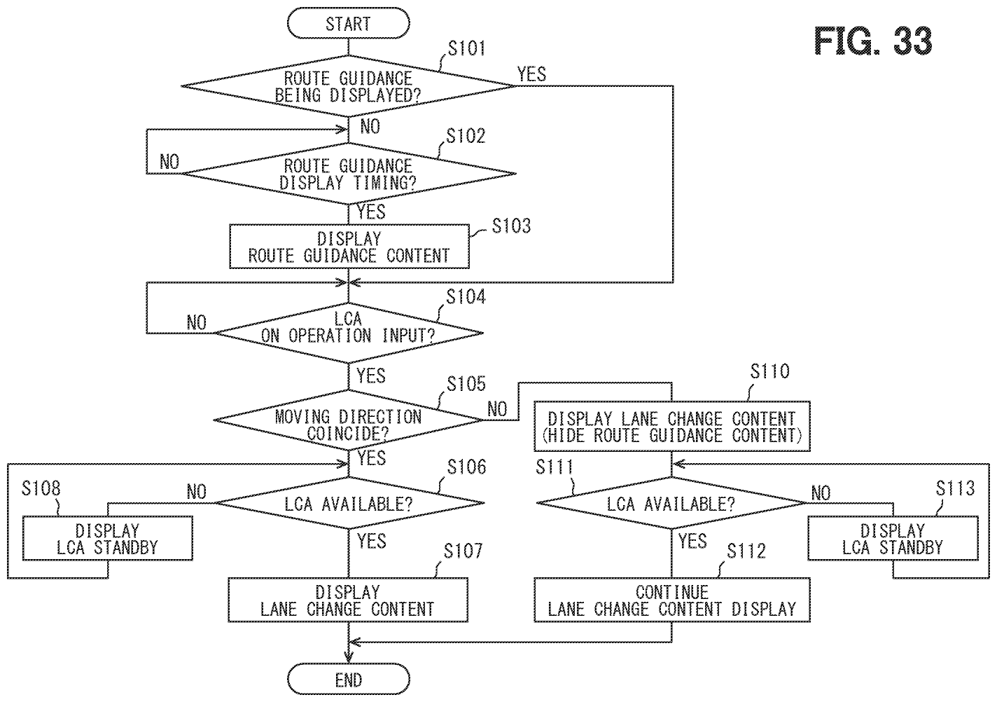

In the first and eighth embodiments described above, the display control process is set on the premise that the reroute process is performed after the vehicle A has passed the reference point GP. On the other hand, in a sixth modification of the embodiments described above, the step related to the display arbitration after the rerouting may be omitted in the display control process. Specifically, in the display control process of the sixth modification shown in FIG. 33, the display generation unit 76 returns to the determination of S106 after starting or continuing the LCA standby display in S108. As described above, the display of the standby content CTw and the display of the standby icon CTwi are continued by repeating S106 and S108, and a series of display control processes are terminated based on the cancellation of the lane change. The processes carried out in S101 to S113 of FIG. 33 is substantially the same as those of the first embodiment (see FIG. 12).

In a seventh modification of the embodiments described above, the superimposition position of the lane change content CTc is adjusted according to the superimposition position of the route guidance content CTg. Even in the seventh modification, the displacements of the superimposition positions of the two superimposition contents CTs can be reduced. Further, in an eighth modification of the embodiments described above, the adjustment process for matching the superposed positions of the lane change content CTc and the route guidance content CTg may be omitted.

In each of the contents of the embodiments described above, static elements such as display color, presence or absence of gradation, display brightness, reference display shape, and dynamic elements such as presence or absence of blinking, cycle of blinking, presence or absence of animation, operation of animation, and the like may be modified as appropriate. Also, the static or dynamic elements of each content may be variable according to the driver's preferences. The traveling scenes described above to explain the route guidance displays of the embodiments and modifications are examples. The HCU can perform displays related to the route guidance and the control information notification using both the non-superimposition content and the superimposition content in traveling driving scenes different from the above.

The HCU 100 of the embodiment described above sequentially controls the projection shape and the projection position of the virtual image light imaged as the superimposition content CTs by using the position information of the eye point detected by DSM27 so that the superimposition content is superimposed on the superimposition target without deviation when viewed from the driver. Alternatively, as a ninth modification of the embodiments described above, the HCU 100 may not use the detection information of the DSM 27, but may control the projection shape and the projection position of the virtual image light imaged as the superimposition content CTs by using the setting information of the center of the reference eye point set in advance, without using the detection information of the DSM 27.

As a tenth modification, the projector 21 of the HUD 20 is provided with an EL (Electro Luminescence) panel, in place of the LCD panel and the backlight. Further, in place of the EL panel, the HUD 20 may employ a projector using a display such as a plasma display panel, a cathode ray tube and an LED, in place of the EL panel.

As an eleventh modification, the HUD 20 is provided with a laser module (hereinafter referred to as LSM) and a screen, in place of the LCD and the backlight. The LSM includes, for example, a laser light source, a micro electro mechanical systems (MEMS) scanner, and the like. The screen is, for example, a micromirror array or a microlens array. In such a HUD 20, a display image is drawn on the screen by scanning the laser beam emitted from the LSM. The HUD 20 projects the display image drawn on the screen onto the windshield WS by the magnifying optical element, and displays the virtual image Vi in the air.

As a twelfth modification, the HUD 20 is provided with a digital light processing (DLP, registered trademark) projector. The DLP projector has a digital mirror device (hereinafter referred to as DMD) provided with a large number of micromirrors, and a projection light source that projects light toward the DMD. The DLP projector draws a display image on the screen under the control of linking the DMD and the projection light source.

As a thirteenth modification, the HUD 20 is provided with a projector using LCOS (Liquid Crystal On Silicon). As a fourteenth modification, the HUD 20 is provided with a holographic optical element, as one of the optical systems for displaying the virtual image Vi in the air.

Further, as a fifteenth modification of the embodiment described above, the HCU and the HUD are integrally configured. That is, the processing function of the HCU is mounted on the control circuit of the HUD. In such a fifteenth modification, the HUD corresponds to the “display control device”. Further, the processing function of the HCU may be mounted on the meter ECU, the navigation ECU, the display audio ECU, and the like. In such modifications, the meter device, the navigation device, and the display audio device correspond to the “display control device”.

As a sixteenth modification of the embodiments described above, the HCU 100 is provided with a camera image acquisition unit that acquires the imaged data obtained by capturing the foreground of the subject vehicle, which is the imaged data of the front camera 31. The display generation unit 76 generates video data in which the original images of such as the route guidance content CTg, the lane change content CTc, the standby content CTw, and the LTA execution content CTt are superimposed on the real image of the foreground based on the captured data. Based on such video data, the HUD 20 projects a display in which each superimposed content CTs is superimposed on a real image as a virtual image Vi on the foreground. As described above, when the angle of view VA of the HUD 20 is not sufficient, in a scene where the AR content deviates from the angle of view VA, the virtual image display in which the original image of such as the content used for the AR display is superimposed on the real image may be performed.

As a seventeenth modification of the embodiments described above, the function of specifying the position of the subject vehicle lane Lns is provided not in the driving assistance ECU 50 but in the locator ECU 44. The locator ECU 44 combines the locator information and the high-precision map data to specify the position of the subject vehicle lane Lns. The locator ECU 44 provides the lane identification information generated to the locator information acquisition unit 73 together with the locator information.

As an eighteenth modification of the embodiments described above, in place of the navigation device 55, a user terminal such as a smartphone is connected to the HCU 100 as an electronic device for route guidance. The display generation unit 76 displays the route guidance content CTg based on the route information acquired from the user terminal. In addition, the display generation unit 76 displays the lane change content CTc when the line shape information indicating the scheduled travel route is acquired from the driving assistance ECU 50 or the automatic driving ECU. Also in such an eighteenth modification, the display generation unit 76 can perform display arbitration between the route guidance content CTg and the lane change content CTc, and display the lane change content CTc in preference to the route guidance content CTg.

In the embodiments described above, the respective functions provided by the HCU can be also provided by software and hardware for executing the software, only software, only hardware, and complex combinations of software and hardware. In cases where these functions are provided by electronic circuits as hardware, the respective functions can be also provided by analog circuits or digital circuits which include a large number of logic circuits.

Further, the specific implementation of the storage medium for storing the program or the like capable of executing the above-described display control method may be changed as appropriate. For example, the storage medium is not limited to the configuration provided on the circuit board, and may be provided in the form of a memory card or the like. The storage medium may be inserted into a slot portion, and electrically connected to the control circuit of the HCU. The storage medium may include an optical disk which forms a source of programs to be copied into a HCU, a hard disk drive therefor, and the like.

The vehicle equipped with the HMI system is not limited to a general private car, but may be a rented vehicle, a vehicle for man-driving taxi, a vehicle for sharing vehicle service, a freight vehicle, a bus, or the like. Further, the HMI system including the HCU may be equipped to a driverless vehicle used for the mobility service.

The vehicle equipped with the HMI system may be a right-hand drive vehicle or a left-hand drive vehicle. Further, the traffic environment in which the vehicle travels may be a traffic environment premised on left-hand traffic, or may be a traffic environment premised on right-hand traffic. The route guidance display and the LCA-related display according to the present disclosure are appropriately optimized according to the Road Traffic Law of each country and region, the steering wheel position of the vehicle, and the like.

The processing unit and the method thereof which have been described in the present disclosure may be also implemented by a special purpose computer which includes a processor programmed to execute one or more functions implemented by computer programs. Also, the device and the method therefor which have been described in the present disclosure may be realized by a special purpose hardware logic circuit. Also, the device and the method therefor which have been described in the present disclosure may be realized by one or more dedicated computers which are constituted by combinations of a processor for executing computer programs and one or more hardware logic circuits. The computer programs may be stored, as instructions to be executed by a computer, in a tangible non-transitory computer-readable medium.

What is claimed is:

1. A display control device for a vehicle to control a display on a head-up display, the vehicle having a function of performing a lane change control based on a driver's input, the display control device comprising:
a route information acquisition unit that acquires route information of the vehicle, and
a display control unit that displays a route guidance content providing a route guidance based on the route information to be superimposed on a road surface, and displays a lane change content indicating a control content of the lane change control to be superimposed on a road surface, wherein
in response to a display request to display one of the route guidance content and the lane change content being generated while the other is being displayed, the display control unit displays the lane change content in preference to the route guidance content.

2. The display control device according to claim 1, wherein
when a movement direction indicated by the route information and a movement direction by the lane change control do not coincide, the display control unit displays the lane change content in preference to the route guidance content.

3. The display control device according to claim 1, wherein
when a range of the route guidance content assumed to be superimposed on a specific lane and a range of the lane change content assumed to be superimposed on the specific lane overlap with each other, the display control unit displays the range of the lane change content in preference to the range of the route guidance content.

4. The display control device according to claim 1, wherein
the display control unit changes a mode of a priority display, in which the lane change content is displayed in preference to the route guidance content, according to a distance to a guidance point at which the route guidance is performed.

5. The display control device according to claim 1, wherein
the display control unit changes a mode of a priority display, in which the lane change content is displayed in preference to the route guidance content, according to a ratio of the route guidance content displayed within an angle of view of the head-up display.

6. The display control device according to claim 1, wherein
when the lane change content and the route guidance content are displayed to be superimposed on the road surface of a same traveling lane, the display control unit sets a superimposition range of the route guidance content in a traveling direction of a superimposition range of the lane change content.

7. The display control device according to claim 1, wherein
in response to the route information acquisition unit acquiring the route information of a re-searched route while waiting for the lane change control, the display control unit suspends display of the route guidance content for guiding the re-searched route.

8. The display control device according to claim 7, wherein
the display control unit begins to display the route guidance content for guiding the re-searched route after terminating display of the lane change content.

9. The display control device according to claim 1, wherein
in response to the route information acquisition unit acquiring the route information of a re-searched route while waiting for the lane change control, the display control unit displays the route guidance content for guiding the re-searched route together with the lane change content.

10. The display control unit according to claim 1, wherein
the display control unit adjusts a superimposed position of one of the lane change content and the route guidance content according to a superimposed position of the other.

11. The display control unit according to claim 1, wherein
the display control unit adjusts a superimposed position of the route guidance content using information acquired for a superimposed display of the lane change content.

12. A display control program product for a vehicle to control a display on a head-up display, the vehicle having a function of performing a lane change control based on a driver's input, the display control program product being stored in a computer-readable non-transitory tangible storage medium, the display control program product including instructions to be executed by one or more processors, the instructions comprising:
acquiring route information of the vehicle;
displaying a route guidance content providing a route guidance based on the route information to be superimposed on a road surface;
displaying a lane change content indicating a control content of the lane change control to be superimposed on a road surface; and
in response to a display request to display one of the route guidance content and the lane change content being generated while the other is being displayed, displaying the lane change content in preference to the route guidance content.
